(19) United States
(12) Patent Application Publication
(10) Pub. No.: US 2026/0129110 A1
(43) Pub. Date: May 7, 2026

(54) TECHNIQUES FOR PDU SET-AWARE APPLICATIONS AND ASSOCIATED SIGNALING

(71) Applicant: Lenovo (Singapore) Pte. Ltd., Singapore (SG)

(72) Inventors: Razvan-Andrei Stoica, Witten (DE); Joachim Löhr, Wiesbaden (DE); Prateek Basu Mallick, Dreieich (DE); Ravi Kuchibhotla, Chicago, IL (US)

(21) Appl. No.: 19/114,418

(22) PCT Filed: Nov. 27, 2023
(86) PCT No.: PCT/IB2023/061943

§ 371 Date: Mar. 21, 2025

Related U.S. Application Data
(60) Provisional application No. 63/428,026, filed on Nov. 25, 2022.
(60) Provisional application No. 63/530,927, filed on Aug. 4, 2023.

(51) Int. Cl. H04L 69/322; H04L 43/0817

(52) U.S. Cl. CPC H04L 69/322; H04L 43/0817

(57) ABSTRACT

Various aspects of the present disclosure relate to PDU set-aware multimedia applications and associated signaling. An NE includes at least one memory and at least one processor configured to cause the NE to encode media of an application into a plurality of application data units (ADUs) as logically independent units of information, group, by an application real-time transport protocol (RTP) sender routine, each ADU into one or more protocol data unit (PDU) sets, determine, for each of the PDU sets, PDU set information, encapsulate the PDU set information for each of the PDUs in the PDU set in an extension header element packetized within an RTP extension header of an RTP PDU corresponding to the RTP PDU payload of each of the one or more PDUs of the PDU set, and transmit the RTP PDUs comprising the PDU set information.

### FIELD

The subject matter disclosed herein relates generally to wireless communications and more particularly relates to techniques for packet data unit (PDU) set-aware applications and associated signaling.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### BRIEF SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further encode media of an application into a plurality of application data units (ADUs) as logically independent units of information, group, by an application real-time transport protocol (RTP) sender routine, each ADU into one or more PDU sets, determine, for each of the PDU sets, PDU set information, encapsulate the PDU set information for each of the PDUs in the PDU set in an extension header element packetized within an RTP extension header of an RTP PDU corresponding to the RTP PDU payload of each of the one or more PDUs of the PDU set, and transmit the RTP PDUs comprising the PDU set information.

Some implementations of the method and apparatuses described herein receive an RTP PDU set, an RTP PDU comprising an extension header with an extension header element comprising PDU set information and a PDU payload, extract the PDU set information from the extension header element for each RTP PDU of the PDU set, the PDU set information comprising identifiers for the PDU set and the PDUs within the PDU set, and a set of PDU set attributes of the PDU set, packetize each of the RTP PDUs of the PDU set and the corresponding PDU set information within a general packet radio service (GPRS) tunnelling protocol for user plane (GTP-U) PDU, the GTP-U PDU comprising each of the RTP PDUs of the PDU set encapsulated as a GTP-U payload and each of the corresponding PDU set information encapsulated as a GTP-U header field, and transmit the GTP-U encapsulated PDU set and corresponding PDU set information.

### BRIEF DESCRIPTION OF THE DRAWINGS

FIG. 1 illustrates an example of a wireless communications system in accordance with aspects of the present disclosure.

FIG. 2 is a diagram illustrating one embodiment of a New Radio (“NR”) protocol stack in accordance with aspects of the present disclosure.

FIG. 3 is a block diagram illustrating one embodiment of a sidelink (SL) protocol stack in accordance with aspects of the present disclosure.

FIG. 4 is a diagram illustrating one embodiment of an extended reality media (XRM) architecture and handling of PDU sets in accordance with aspects of the present disclosure.

FIG. 5 is a diagram illustrating one embodiment of 5GS PDU set-aware quality of service (QoS) handling framework description of PDU set to QoS flow to data radio bearer (DRB) mappings in accordance with aspects of the present disclosure.

FIG. 6 is a diagram illustrating one embodiment of RTP and real-time control protocol (RTCP) stack over internet protocol (IP) networks in accordance with aspects of the present disclosure.

FIG. 7 is a diagram illustrating one embodiment of WebRTC secure real-time transport protocol (SRTP) stack over IP networks in accordance with aspects of the present disclosure.

FIG. 8 is a diagram illustrating one embodiment of RTP/SRTP packet formats and header information in accordance with aspects of the present disclosure.

FIG. 9 is a diagram illustrating one embodiment of RTP/SRTP header extension format and syntax in accordance with aspects of the present disclosure.

FIG. 10 is a diagram illustrating one embodiment of a representation of PDU set and PDU set information determination and signaling with respect to both downlink (DL) and uplink (UL) transmissions over the user plane of a 5GS in accordance with aspects of the present disclosure.

FIG. 11 is a diagram illustrating one embodiment of an overview of RTP PDU packetization without PDU set awareness and RTP PDU packetization with PDU set awareness, including PDU set and PDU set information determination in accordance with aspects of the present disclosure.

FIG. 12 is a diagram illustrating one embodiment of an example of a generic PDU set information extension header payload in accordance with aspects of the present disclosure.

FIG. 13 is a diagram illustrating one embodiment of an example of RTP header extension format for a generic PDU set information in accordance with aspects of the present disclosure.

FIG. 14 is a diagram illustrating one embodiment of an example of a one-byte RTP header extension format of a PDU set information extension header element in accordance with aspects of the present disclosure.

FIG. 15 is a diagram illustrating one embodiment of an example of multiplexing a one-byte RTP header extension element containing a PDU set information with a two-byte RTP header extension element in accordance with aspects of the present disclosure.

FIG. 16 illustrates an example of a UE in accordance with aspects of the present disclosure.

FIG. 17 illustrates an example of a processor in accordance with aspects of the present disclosure.

FIG. 18 illustrates an example of a network equipment (NE) in accordance with aspects of the present disclosure.

FIG. 19 illustrates a flowchart of a method performed by a UE, NE, or processor in accordance with aspects of the present disclosure.

FIG. 20 illustrates a flowchart of a method performed by a UE, NE, or processor in accordance with aspects of the present disclosure.

### DETAILED DESCRIPTION

Generally, the present disclosure describes systems, methods, and apparatus for PDU set-aware multimedia applications and associated signaling. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In the context of XR media traffic, 3GPP SA2 WG recently introduced the concept of PDU set to group a series of PDUs carrying a unit of information at the application-level. A PDU set can thus be treated according to an identical set of QoS requirements and associated constraints of delay budget and error rate while providing support to a radio access network (“RAN”) for differentiated QoS handling at PDU set level. This improves the granularity of legacy 5G QoS flow framework allowing the RAN to optimize the mapping between QoS flow and DRBs to meet stringent XR media requirements (e.g., high-rate transmissions with short delay budget).

One problem related to the latter activity is how the PDU set information (e.g., PDU set boundaries, PDU set importance) is communicated between an application and the 5GS. The current disclosure treats the problem from an application-centric perspective whereby the application, i.e., either the application logic on a UE device or the application server of the application provider, determine and signal the PDU set information to the 5GS core network. This signaling is provided in real-time with low signaling/control overhead to enable QoS performance benefits based on the PDU set concept.

Hereafter XR is used as an umbrella term for different types of realities, including. For instance, VR is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (“HMD”), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

In another example, AR is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

MR is an advanced form of AR where some virtual elements are inserted into the physical scene with the intent to provide the illusion that these elements are part of the real scene.

XR refers to real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Aspects of the present disclosure are described in the context of a wireless communications system.

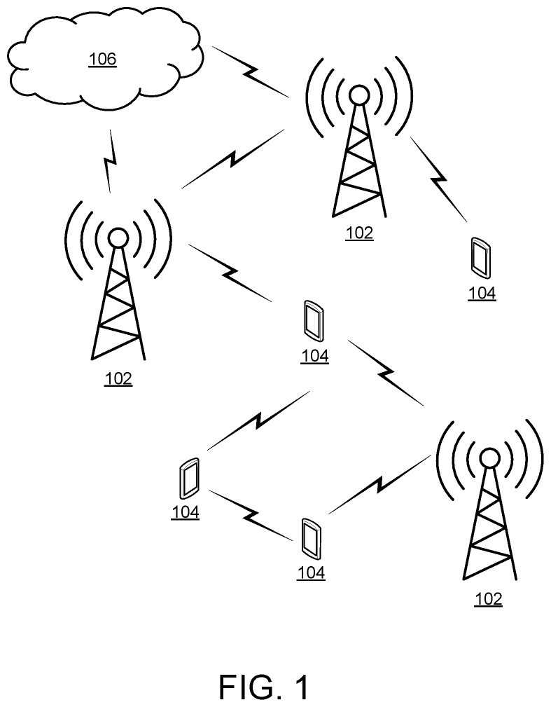

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FRI (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing: a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

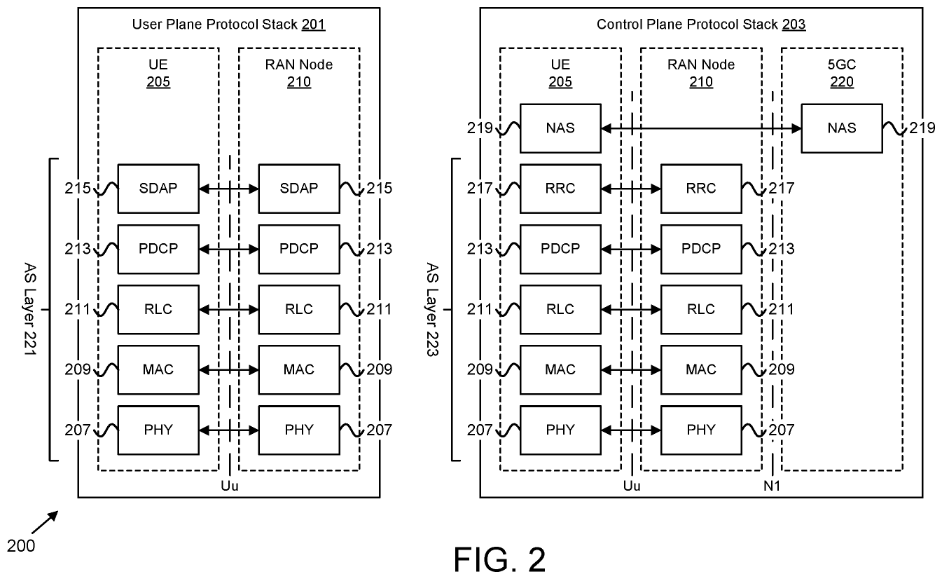

FIG. 2 depicts a NR protocol stack 200, according to embodiments of the disclosure. While FIG. 2 shows the UE 205, the RAN node 210 and a 5GC 220, these are representative of a set of remote units 105 interacting with a base unit 121 (or gNB) and a mobile core network 140. As depicted, the NR protocol stack 200 comprises a User Plane protocol stack 201 and a Control Plane protocol stack 203. The User Plane protocol stack 201 includes a physical (“PHY”) layer 207, a Medium Access Control (“MAC”) sublayer 209, the Radio Link Control (“RLC”) sublayer 211, a Packet Data Convergence Protocol (“PDCP”) sublayer 213, and Service Data Adaptation Protocol (“SDAP”) layer 215. The Control Plane protocol stack 203 includes a PHY layer 207, a MAC sublayer 209, a RLC sublayer 211, and a PDCP sublayer 213. The Control Plane protocol stack 203 also includes a Radio Resource Control (“RRC”) layer 217 and a NAS layer 219.

The AS layer 221 (also referred to as “AS protocol stack”) for the User Plane protocol stack 201 consists of at least SDAP, PDCP, RLC and MAC sublayers, and the physical layer. The AS layer 223 for the Control Plane protocol stack 203 consists of at least RRC, PDCP, RLC and MAC sublayers, and the physical layer. The Layer-1 (“L1”) consists of the PHY layer 207. The Layer-2 (“L2”) is split into the SDAP, PDCP, RLC and MAC sublayers. The Layer-3 (“L3”) includes the RRC sublayer 217 and the NAS layer 219 for the control plane and includes, e.g., an Internet Protocol (“IP”) layer or PDU Layer (note depicted) for the user plane. L1 and L2 are referred to as “lower layers,” while L3 and above (e.g., transport layer, application layer) are referred to as “higher layers” or “upper layers.”

The PHY layer 207 offers transport channels to the MAC sublayer 209. The MAC sublayer 209 offers logical channels to the RLC sublayer 211. The RLC sublayer 211 offers RLC channels to the PDCP sublayer 213. The PDCP sublayer 213 offers radio bearers to the SDAP sublayer 215 and/or RRC layer 217. The SDAP sublayer 215 offers QoS flows to the core network (e.g., 5GC 220). The RRC layer 217 provides for the addition, modification, and release of Carrier Aggregation and/or Dual Connectivity. The RRC layer 217 also manages the establishment, configuration, maintenance, and release of Signaling Radio Bearers (“SRBs”) and Data Radio Bearers (“DRBs”).

The NAS layer 219 is between the UE 205 and an AMF in the 5GC 220. NAS messages are passed transparently through the RAN. The NAS layer 219 is used to manage the establishment of communication sessions and for maintaining continuous communications with the UE 205 as it moves between different cells of the RAN. In contrast, the AS layers 221 and 223 are between the UE 205 and the RAN (i.e., RAN node 210) and carry information over the wireless portion of the network. While not depicted in FIG. 2, the IP layer exists above the NAS layer 219, a transport layer exists above the IP layer, and an application layer exists above the transport layer.

The MAC sublayer 209 is the lowest sublayer in the L2 architecture of the NR protocol stack. Its connection to the PHY layer 207 below is through transport channels, and the connection to the RLC sublayer 211 above is through logical channels. The MAC sublayer 209 therefore performs multiplexing and demultiplexing between logical channels and transport channels: the MAC sublayer 209 in the transmitting side constructs MAC PDUs (also known as transport blocks (“TBs”)) from MAC Service Data Units (“SDUs”) received through logical channels, and the MAC sublayer 209 in the receiving side recovers MAC SDUs from MAC PDUs received through transport channels.

The MAC sublayer 209 provides a data transfer service for the RLC sublayer 211 through logical channels, which are either control logical channels which carry control data (e.g., RRC signaling) or traffic logical channels which carry user plane data. On the other hand, the data from the MAC sublayer 209 is exchanged with the PHY layer 207 through transport channels, which are classified as UL or DL. Data is multiplexed into transport channels depending on how it is transmitted over the air.

The PHY layer 207 is responsible for the actual transmission of data and control information via the air interface, i.e., the PHY layer 207 carries all information from the MAC transport channels over the air interface on the transmission side. Some of the important functions performed by the PHY layer 207 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 217. The PHY layer 207 performs transmissions based on transmission parameters, such as the modulation scheme, the coding rate (i.e., the modulation and coding scheme (“MCS”)), the number of physical resource blocks, etc.

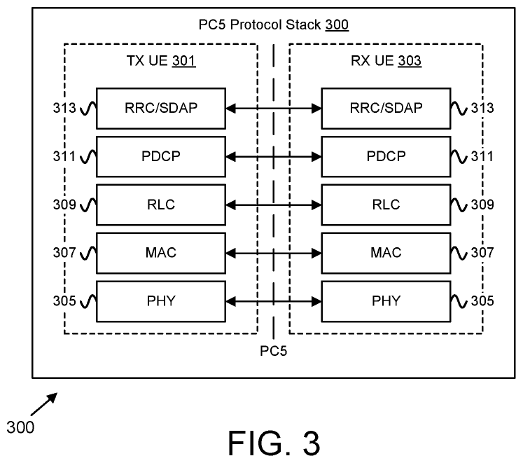

FIG. 3 depicts a SL protocol stack 300, according to embodiments of the disclosure. While FIG. 3 shows a transmitting SL UE 301 (denoted “Tx UE”) and a receiving SL UE 303 (denoted “Rx UE”), these are representative of a set of UEs communicating peer-to-peer via a PC5 interface, and other embodiments may involve different UEs. As depicted, the protocol stack 300 includes a physical layer 305, a MAC sublayer 307, a RLC sublayer 309, a PDCP sublayer 311, and RRC and SDAP layers (depicted as combined element “RRC/SDAP” 313), for the control plane and user plane, respectively. The physical layer 305, the MAC sublayer 307, the RLC sublayer 309, the PDCP sublayer 311, and the RRC/SDAP layers 313 may perform substantially the same functions described above with reference to the NR protocol stack 200, but supporting UE-to-UE communications between the Tx UE 301 and the Rx UE 303.

The AS protocol stack for the control plane in the SL protocol stack 300 consists of at least RRC, PDCP, RLC and MAC sublayers, and the physical layer. The AS protocol stack for the user plane in the SL protocol stack 300 consists of at least SDAP, PDCP, RLC and MAC sublayers, and the physical layer. The L2 is split into the SDAP, PDCP, RLC and MAC sublayers. The L3 includes the RRC sublayer for the control plane and includes, e.g., an IP layer for the user plane. L1 and L2 are referred to as “lower layers”, while L3 and above (e.g., transport layer, V2X layer, application layer) are referred to as “higher layers” or “upper layers.”

Regarding PDU set within Core Network, the study of XRM in Release 18 at the CN level introduced the concept of a PDU set to handle QoS requirements of XRM applications and streams with a better granularity beyond QoS flow possibilities. As such, according to “3GPP Technical Report TR 23.700-60 (v0.0.3—May 2022). Study on XR (Extended Reality) and media services” (hereinafter “Study on XR”, incorporated herein by reference), a PDU set is composed of one or more PDUs carrying the payload of one unit of information generated at the application level (e.g. a frame or video slice for XRM Services). In some implementations all PDUs in a PDU Set are needed by the application layer to use the corresponding unit of information. In other implementations, the application layer can still recover parts or all of the information unit, when some PDUs are missing.

In addition, the PDU set is associated with QoS requirements in terms of delay budget and error rate as, cf. “Study on XR”, “3GPP Technical Specification TS 23.501 (v17.5.0—June 2022). System architecture for the 5G System (5GS)” (hereinafter “System architecture for the 5G System”, incorporated herein by reference).

For instance, a PDU Set Delay Budget (PSDB) which defines an upper bound for the time that a PDU-Set may be delayed between the UE and the N6 termination point at the UPF. PSDB applies to the DL PDU-Set received by the UPF over the N6 interface, and to the UL PDU-Set sent by the UE.

Further, a PDU Set Error Rate (PSER) which defines an upper bound for the rate of PDU-Sets (e.g. set of IP packets constituting a PDU-Set) that have been processed by the sender of a link layer protocol (e.g. RLC in RAN of a 3GPP access) but where all of the PDUs in the PDU-Set are not successfully delivered by the corresponding receiver to the upper layer (e.g. PDCP in RAN of a 3GPP access), whereas the PSER is used to determine an upper bound for a rate of non-congestion-related packet losses.

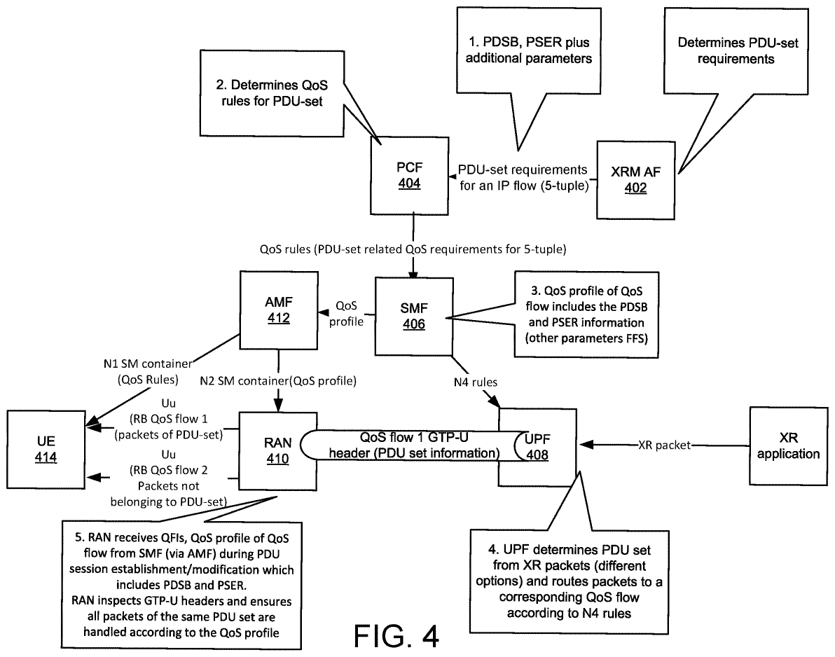

An overview of the CN XRM architecture handling of PDU sets is depicted in FIG. 4.

The general processing steps for DL traffic include the Application Function (“AF”) 402 that provides QoS requirements for packets of a PDU set to the PCF 404 (e.g., PSDB and PSER) and information to identify the application (i.e. 5-tuple or application id). The AF 402 may also include an importance parameter for a PDU set and information for the core network to identify packets belonging to a PDU set. In one embodiment, the PDU set importance field/parameter linearly encodes l=16 importance values, wherein a ‘0’ encoding value indicates a highest PDU set importance and a ‘15’ encoding value indicates a lowest PDU set importance. As used herein, linearly means: 0>1>2> . . . >15 in terms of PDU set importance, where 0 is most important and 15 the least important.

The PCF 404 that derives QoS rules for the XR application (i.e. use a 5QI for XR media traffic) and specific QoS requirements for the PDU set and configures the SMF 406. The PCF 404 may include PCC rules per importance of a PDU set (according to information received from the AF or based on operator configuration).

The SMF 406 establishes a QoS flow according to the QoS rules by the PCF 404 and configures the UPF 408 to route packets of the XR application to a QoS flow, and, in addition, to enable PDU set handling. The SMF 406 also provides the QoS profile containing PDU set QoS requirements to the RAN 410 via the AMF 412.

The UPF 408 inspects the packets and determines packets belonging to a PDU set (e.g. by inspecting the RTP packets). When the UPF 408 detects packets of a PDU set the UPF 408 marks the packets belonging to a PDU set within a GTP-U header. The GTP-U header information includes a PDU set sequence number and the size of the PDU set. The UPF 408 may also determine the importance of the PDU set either based on UPF 408 implementation means, information provided by the AF 402 or information provided as metadata from the application server. Based on the importance of the PDU set the UPF 408 may route the traffic to a corresponding QoS flow (according to the rules received from the SMF) or include the importance of the PDU set within a GTP-U header.

The RAN 410 that identifies packets belonging to a PDU set (based on the GTP-U marking) and handles the packets of the PDU-set according to the QoS requirements of the PDU set provided by the SMF 406. In one implementation the RAN node may use a different radio bearer with higher QoS requirement (according to the PDU set PSDB/PSER) to guarantee delivery of the packets of the PDU-set, while use a different radio bearer according to the 5QI of the QoS flow for the non-PDU-set packets.

Reciprocal processing is applicable to UL whereas the role of UPF packet inspection is taken by the UE 414 which is expected to inspect packets, determine packets belonging to a PDU set, and signal accordingly the PDU set to the RAN for scheduling and resource allocation corresponding to an associated DRB fulfilling capable of fulfilling the PDU set QoS requirements (i.e., PSDB and PSER). The low-level signaling mechanism associated with the UL UE-to-RAN information passing are up to the specification and implementations of RAN signaling procedures.

Depending on the QoS flow mappings and RAN procedures, several alternative PDU set to QoS flow to DRB mappings are possible given two distinct PDU sets with different PDU set attributes, such as PDU set importance.

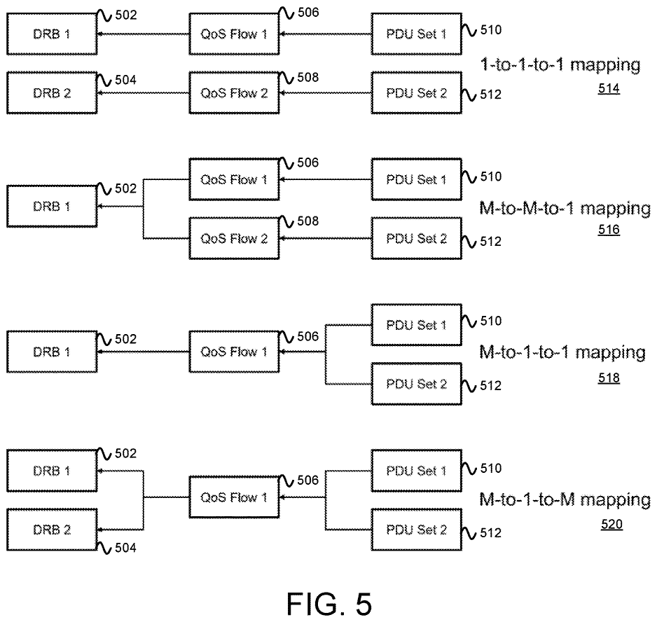

FIG. 5 illustrates this were 2 PDU sets 510, 512 of different importance and characteristics are being mapped to QoS flows 506, 508 and respectively to DRBs 502, 504. Consider in this example PDU set 1 510 to be of high importance with strict QoS requirements (i.e., PSDB, PSER etc.) and PDU set 2 512 to be of low importance with potentially lower QoS requirements (i.e., PSDB, PSER etc.) than PDU set 1 510. As illustrated in FIG. 5, the PDU set to QoS flow to DRB can take the following instantiations depending on QoS flow policies and Layer 2 RAN procedures.

1-to-1-to-1 514: whereby the separation of QoS flows 506, 508 and DRBs 502, 504 is complete between high and low importance PDU sets 510, 512 optimizing finely the radio and network resources on a per PDU set basis.

M-to-M-to-1 516: whereby the separation between high and low importance PDU sets 510, 512 is performed only at QoS flow level 506, 508, whereas the same DRB 502 is used for the over-the-air transmission of both PDU sets 510, 512, which may lead to overprovisioning of radio resources for low importance PDU sets yet require a lower overhead of RAN complexity and management.

M-to-1-to-1 518: whereby there is no separation between the QoS flows 506 and DRBs 502 of different importance PDU sets 510, 512 and the higher importance PDU set QoS requirements are priority in handling the QoS management across both CN and RAN: this may lead to overprovisioning of resources for low importance PDU sets in both CN and RAN implementations but requires lower overhead and control within the 5GS QoS framework.

M-to-1-to-M 520: whereby there is no separation across the QoS flows 506 between PDU set importance levels, yet distinct DRBs 502, 504 are used to cater for the individual requirements of the distinct importance levels: this compromises the QoS flow management complexity and uses PDU set information to filter the PDU sets 510, 512 on different DRBs 502, 504 in order to better match the QoS requirements at RAN level and optimize resource allocation according to individual PDU set needs.

Regarding media transport protocol, In Release 17 SA4 analyzed the XR traffic model, cf. “3GPP Technical Report TR 26.926 (v1.1.0-February 2022). Traffic Models and Quality Evaluation Methods for Media and XR Services in 5G Systems.” (hereinafter “Traffic Models”, incorporated herein by reference), and concluded the QoS requirements in terms of delay budget, data rate and error rate necessary for a satisfactory experience at the application level. These led to 4 additional 5QIs for the 5GS XR QoS flows, as part of Table 5.7.4-1 of “System architecture for the 5G System” as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

The traffic of immersive and interactive XR applications as the ones described above require often real-time suited transport architectures and protocols. As part of the latter, the state of art is represented by the Real-time Transport Protocol (RTP) (according to “RFC 3550-RTP: A Transport Protocol for Real-Time Applications (ietf.org)” (hereinafter “RFC 3550”, incorporated herein by reference)), its securely provisioned Secure Real-time Transport Protocol (SRTP) [Ref-6], and its web-targeted stack Web Real-Time Communications WebRTC (according to “WebRTC 1.0: Real-Time Communication Between Browsers (w3.org)” (hereinafter “WebRTC 1.0”, incorporated herein by reference)), respectively.

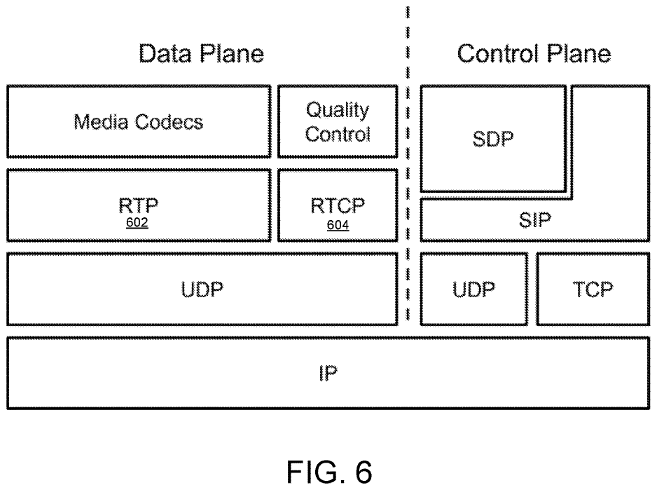

As shown in FIG. 6, RTP 602 is a media codec agnostic network protocol with application-layer framing used to deliver multimedia (e.g., audio, video etc.) data in real-time over IP networks, cf. RFC 3550. It is used in conjunction with a sister protocol for control, i.e., Real-time Transport Control Protocol (RTCP) 604, to provide end-to-end features such as jitter compensation, packet loss and out-of-order delivery detection, synchronization, and source streams multiplexing.

SRTP is a secured version of RTP, cf. “RFC 3711—The Secure Real-time Transport Protocol (SRTP) (ictf.org)” (hereinafter “RFC 3711”, incorporated herein by reference), providing encryption (mainly by means of payload confidentiality), message authentication and integrity protection (by means of PDU, i.e., headers and payload, signing), as well as replay attack protection. Similarly to RTP, the SRTP sister protocol is SRTCP. This provides the same functions to its RTCP counterpart. As such, in vanilla SRTP versions, the RTP header information is still accessible but non-modifiable, whereas the payload is encrypted. These security provisions are illustrated in part over the right-hand side ofError! Reference source not found. FIG. 6. Furthermore, the key exchange and additional security parameters necessary to use SRTP are based upon the Datagram Transport Layer Security (DTLS) key exchange procedure. SRTP is used for these reasons as the transport protocol for media in the WebRTC stack which ensures secure RTC multimedia communications over web browser interfaces.

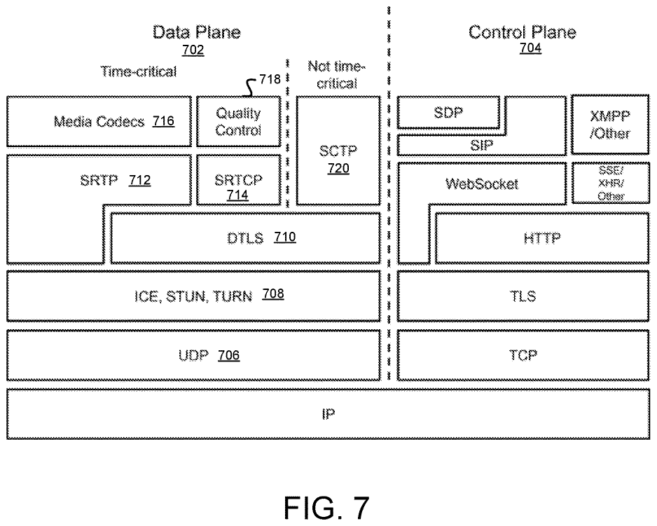

An overview of the WebRTC stack is provided in FIG. 7. As illustrated, an IP layer carries signaling from the data plane 702 and the control plane 704. The data plane stack comprises functions for User Datagram Protocol (UDP) 706, Interactive Connectivity Establishment (ICE) 708, Datagram Transport Layer Security (DTLS) 710, SRTP 712, SRTCP 714, media codecs 716, Quality Control 718 and SCTP 720. ICE 708 may use the Session Traversal Utilities for NAT (STUN) protocol and Traversal Using Relays around NAT (TURN) to address real-time media content delivery across heterogeneous networks and NAT rules and firewalls. The SCTP 720 data plane is mainly dedicated as an application data channel and may be non-time critical, whereas the SRTP 712 based stack including elements of control, i.e., SRTCP 714, encoding, i.e., media codecs 716, and Quality of Service (QoS), i.e., Quality Control 718, is dedicated to time-critical transport.

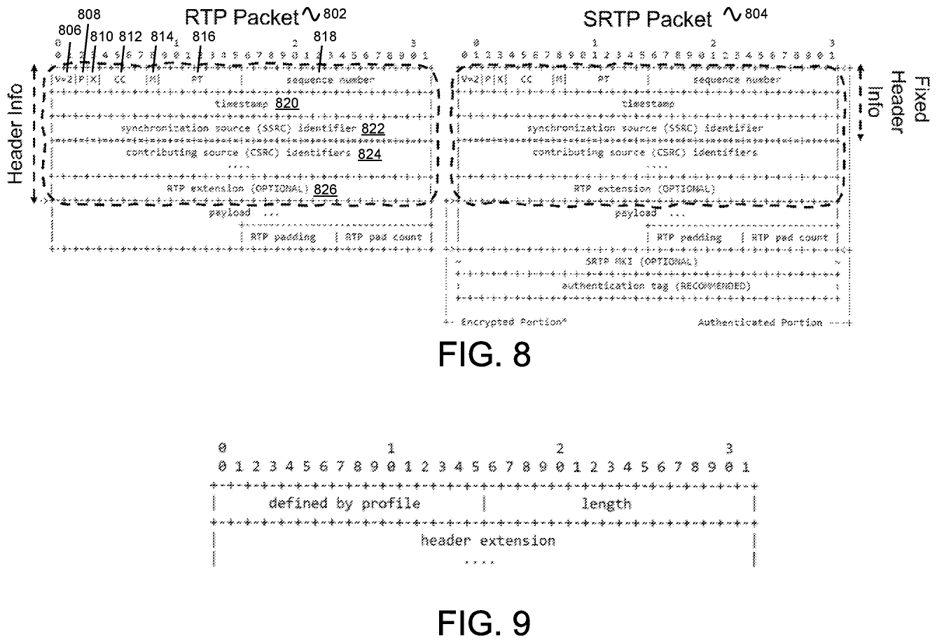

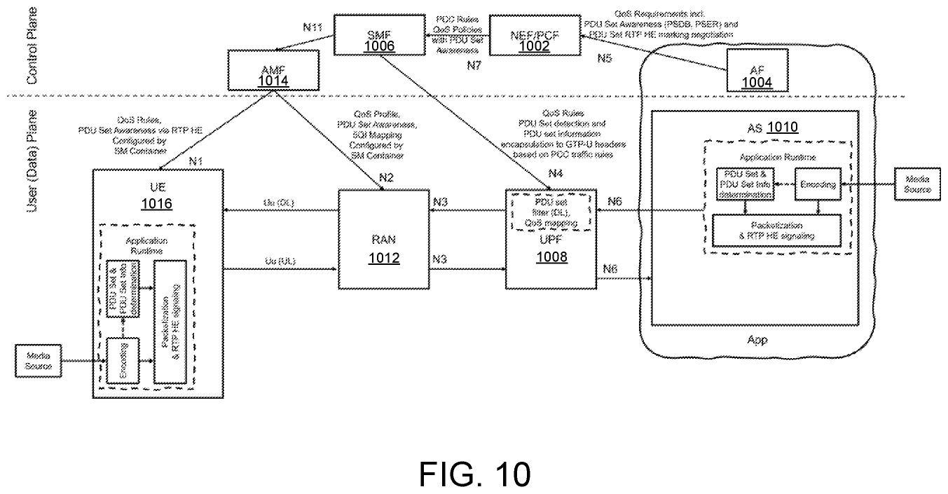

FIG. 8 illustrates the RTP 802 and SRTP 804 header information, which share the same format. The individual fixed header information and complete header information (including header extensions) is briefly summarized, and shown in FIG. 9, for the RTP/SRTP packets as follows:

### Fixed Header Info:

V 806—2 bits indicating the protocol version used.
P 808—1 bit field indicating that one or more zero-padded octets at the end of the payload are present, whereby, among others, the padding may be necessary for fixed-sized encrypted blocks or for carrying multiple RTP/SRTP packets over lower layer protocols.
X 810—1 bit indicating that the standard fixed RTP/SRTP header will be followed by an RTP header extension usually associated with a particular data/profile that will carry more information about the data (e.g., the frame marking RTP header extension for video data, cf., “RFC 3711”, or generic RTP header extensions such as the RTP/SRTP extended protocol, cf. “WebRTC 1.0”).
CC 812—4 bits indicating number of contributing media sources (CSRC) that follow the fixed header.
M 814—1 bit intended to mark an information frame boundary in the packet stream, whose behavior is exactly specified by RTP profiles (e.g., H.264, H.265, H.266, AV1 etc.)
PT 816—7 bits indicating the payload type, which in case of video profiles is dynamic and negotiated by means of SDP (e.g., 96 for H.264, 97 for H.265, 98 for AV1 etc.)
Sequence number 818—16 bits indicating the sequence number which increments by one with each RTP data packet sent over a session.
Timestamp 820—32 bits indicating timestamp in ticks of the payload type clock reflecting the sampling instant of the first octet of the RTP data packet (associated for video stream with a video frame), whereas the first timestamp of the first RTP packet is selected at random.
Synchronization Source (SSRC) identifier 822—32 bits field indicating a random identifier for the source of a stream of RTP packets forming a part of the same timing and sequence number space, such that a receiver may group packets based on synchronization source for playback.
Contributing Source (CSRC) identifier 824—list of up to 16 CSRC items of 32 bits each given the amount of CSRC mixed by RTP mixers within the current payload as signaled by the CC bits: the list identifies the contributing sources for the payload contained in this packet given the SSRC identifiers of the contributing sources.

Complete Header Information (incl. header extensions):

RTP header extension 826—a variable length field present if the X bit is marked: the header extension is appended to the RTP fixed header information after the CSRC list if present: the RTP header extension is 32-bit aligned and formed of the following fields:

A 16-bit extension identifier defined by a profile and usually negotiated and determined via the Session Description Protocol (SDP) signaling mechanism.

A 16-bit length field describing the extension header length in 32-bits multiples excluding the first 32 bits corresponding to the 16 bits extension identifier and the 16 bits length fields itself.

A 32-bit aligned header extension raw data field formatted according to some RTP header extension identifier specified format.

The RTP header extension format and syntax are like the ones of SRTP. In addition, in both RTP and SRTP, only one RTP extension header may be appended to the fixed header information, cf. “RFC 3550”. However, for both RTP and SRTP extensions to the base protocols exist to allow for multiple RTP header extensions of predetermined types to be appended to the fixed header information of the protocols, as per “RFC 8285: A General Mechanism for RTP Header Extensions (rfc-editor.org)” (hereinafter “RFC 8285”, incorporated herein by reference).

In some embodiments, RTP header extensions produced at the source may be ignored by the destination endpoints that do not have the knowledge to interpret and process the RTP header extensions transmitted by the source endpoint.

Regarding PSB determination and importance, as per FIG. 4, to determine PDU sets and control the PDU set to QoS flow to DRB mapping for the QoS 5GS framework implies to determine the PDU set boundaries (PSB), determine the PDU set importance (PSI) and additional PDU set characteristics (e.g., PDU set size, PDU set discarding marker, PDU set forward error correction (FEC) information etc.), and/or make available this PDU set information to the CN/RAN and 5GS.

These elements may be solved in some solutions by the UPF for DL whereby the UPF acts as a PDU filter embedding intelligence to determine PSB, PSI and PDU set information. Furthermore, as described in the prequel the UPF will also setup, configure and map PDU sets to appropriate QoS rules by means of QoS flow. This approach of UPF-centric processing of PDU set information and determination of PDU sets has the disadvantage of increased processing on the UPF side which increases the UPF implementation complexity linearly with the number of connections trying to leverage the PDU set concept. This is the case as the UPF solutions that can perform PDU set and PDU set information determination rely on deep packet inspection and RTP header processing increasing buffering and compute requirements on the UPF implementation. Solutions along these lines have been proposed in 3GPP SA2 WG study phase, “Study on XR”, and use RTP packet format to leverage a combination of one or more of the RTP timestamp, sequence number and M-bit marker to determine video frame boundaries. This information is complemented in some solutions by additional information extracted from application-specific and/or profile-specific RTP header extensions (e.g., draft-ietf-avtext-framemarking-13, “RTP Frame Marking RTP Header Extension (November 2021)-draft-ietf-avtext-framemarking-13” (hereinafter “RTP Frame Marking”, incorporated herein by reference) or from parsing the RTP payload headers (e.g., of the video encoded NAL units in H.26x codecs). This last collected information is then used to extract some classification/estimation of the importance of the detected PDU set and to determine the PSB.

However, these solutions are not very tractable in practice due to their disadvantages and to the fact that they are not symmetric with respect to UL processing. In the UL the PDU set and PDU set information determination falls within the UE responsibilities as the UE will use the PDU set information to map PDU sets to appropriate DRBs. The DRBs are mapped over N3 interface according to existent Layer 2 upon SMF configuration to QoS flow by means of SDAP processing. The UPF shall then route the UL to the application server as per the PCF configured QoS rules and SMF setup QoS flow.

The disclosure proposes to use an application-centric design for the determination of PDU sets, PDU set information and signaling of such information to 5GS. The high-level solution relies on the determination at the application runtime of the PDU set boundaries and grouping of PDUs within a PDU set upon encapsulation of XR media data into RTP/SRTP/WebRTC real-time transport protocol, the determination at the application runtime of PDU set characteristics (e.g., PDU set size, PDU set importance, PDUs discardability, i.e., necessity of all PDUs for the usage of the PDU set at the application layer etc.) and extraction of this PDU set information, including PDU set identifier (e.g., as a PDU sequence number), PDUs identifiers within a PDU set (e.g., as PDU sequence number within a PDU set), and/or encapsulation of PDU set information within RTP extension header elements for in-band signaling of PDU set information and complete packetization of all PDUs of the PDU set as RTP/SRTP/WebRTC real-time transport protocol PDUs.

The processing steps above are driven by the source, i.e., applicable to the originating source of an XR media stream. The solution is application-driven and works for both UE and AS as an over-the-top procedure aiding the 5GS QoS framework which thus benefits the PDU set and PDU set information determination and signaling. Furthermore, the proposed in-band signaling allows for interoperability within the 5GS by separating additional complexity and implementation specifics of the PDU set and PDU set information determination from the 5GS.

The high-level solution is displayed in FIG. 10 with reference to the main steps described above for both UL and DL user plane processing of 5GS.

In DL, the PCF 1002 decides on the PCC rules for a QoS flow and PDU set awareness (i.e., RTP header extension configuration capturing RTP header extensions containing PDU set information) based on requirements provided by an AF 1004 over the NEF/PCF interface for or based on operator configuration for a particular type of application, e.g., XR, CG etc. The PCC rules include information to enable PDU set filtering based on application in-band signaling of PDU set information via RTP header extensions. The filters are associated at the UPF with a service data flow of the AS (identified by a 5-tuple).

The PCC rules with PDU set-aware policies are sent to the SMF 1006 over the N7 interface which in turns establishes a QoS flow and provides further N4 rules to the UPF 1008, instructing the UPF 1008 to enable PDU set filtering and QoS mapping to a particular QoS flow given the PDU set acquired information from the RTP header extensions as signaled by the AS 1010 over N6 user plane interface. The UPF 1008 extracts the PDU set awareness and encapsulates the latter with the PDU set payloads within GTP-U headers of the selected QoS flow given the PDU set information and QoS rules with PDU set awareness. The user plane data is transferred to the RAN 1012 over the N3 reference point. The RAN 1012 applies the AMF 1014 signaled QoS profile information via the SM container which includes the new PDU set awareness acquired over the GTP-U headers. The RAN 1012 handles the mapping of the QoS flows to specific DRBs according to the QoS rules and the available PDU set information to fulfill QoS requirements of the application, including 5QIs, PSDB, and PSER constraints.

In UL, the UE 1016 negotiates within the session management (i.e., establishment, update operations) process the PDU set and PDU set information determination and associated signaling via RTP header extensions. This may include direct signaling via AMF 1014 from the SMF 1006 of PDU set filtering policies and QoS rules associated with PDU sets. A PDU set-aware UE 1016 applies the QoS rules and the PDU set policies to process incoming media (including encoding) and determine the PDU set and PDU set information at runtime. Post-packetization of the PDU set and PDU set information into RTP PDUs and RTP header extensions, the UE 1016 will transmit in the UL the data over the Uu interface to the RAN 1012. In doing so, the UE 1016 will further signal its PDU set awareness by selecting a DRB given the SMF QoS rules, PDU set policies and its acquired PDU set awareness. The RAN 1012 will in turn remap the selected DRBs to QoS flows based on SDAP processing of UL data from the UE 1016 and based on the QoS rules and PDU set policies received from the SMF 1006 via the AMF 1014 over the N2 reference point. As a result, the RAN 1012 will transmit uplink data to the UPF 1008 via the N3 interface over an optimized QoS flow and the UPF 1008 will in turn communicate the data with a remote data network over the N6 interface. In summary, the proposed method provides an application-centric PDU set and

PDU set information determination with uniform processing and logic on both server and client sides: interoperable in-band signaling procedure between an AS and 5GS UPF entity over N6 over well-established RTP and WebRTC transport protocols; and reduced processing complexity of UPF/5GS implementation for DL/UL PDU set-aware QoS integrated handling where, in DL, the UPF needs to identify PDU sets based on in-band indication over RTP header extensions coming from an AS by applying a PDU set aware packet filter associated with a 5 tuple for a service data flow of an application and where, in UL, the legacy SDAP based DRB selection mechanisms can be used by a PDU set-aware UE given PDU set-aware QoS rules are negotiated and established over the control plane by the AF.

In a first embodiment directed to determination of PDU set and PDU set information, the determination of PDU sets and corresponding PDU set information is performed by an application at runtime. In an embodiment, the application runtime that processes an input media stream, e.g., a captured video stream, a rendered video stream, a dual-eye stream buffer etc., encodes first the primitive available information. The information may be sourced from an embedded capturing device, i.e., one or multiple RGB/RGBD cameras, from a remote capturing device, i.e., remote camera surveillance system, or from a rendering engine, e.g., Unity OctaneRenderer®, etc.

The encoding procedure involves in an example compressing the raw picture data formats, e.g., R8G8B8A8, or alternatively, R10G10B10, of the video stream to a bitstream by applying a video codec, e.g., H.264, H.265, H.266, VP8, VP9, AV1 etc. The resulted bitstream contains video encoded frames, video encoded frame partitions (i.e., video encoded slices, video encoded tiles), or alternatively, video encoded layers (i.e., video encoded temporal and/or spatial layers) packetized to units of information prepared for transport over a network or storage medium device. These packets containing the video encoded units of information, or alternatively application data units (ADUs), are structured according to syntax and semantic rules of a codec specification, i.e., NALU in H.264, H.265, H.266, Open Bistream Unit (OBUs) in AV1 etc. As a result, an ADU represents the video encoded atomic unit of information that is produced by an encoder and outputted, i.e., copied/written, at once within an output buffer. As such, in some embodiments the ADU is parsed independently by a decoder, yet it may require other ADUs for decoding of the encoded information (e.g., a P-frame/P-slice may require another I/P/B-frame or I/P/B-slice reference). In some embodiments, depending on the encoding configuration, the encoder can output an ADU representing an encoded video frame, an encoded video frame partition (e.g., an encoded video slice, an encoded video tile), an encoded video frame/slice/tile within an encoded video enhancement layer (e.g., as part of a temporal or spatial enhancement layer).

In embodiments pertaining to real-time media communications over networks, each of the ADUs in the encoded bitstream (e.g., video frame, video slice, video tile, video slice corresponding to temporal layer, video slice corresponding to spatial layer etc.) resulted from the encoding procedure is buffered and formatted at runtime into an RTP/SRTP payload. The payload format is determined by an IETF RTP/SRTP AV profile, such as RFC 6184 for H.264, RFC 7798 for H.265, draft-ietf-avcore-rtp-vvc-18 for H.266, matching the encoder used to encode the media.

In an embodiment, depending on the maximum transmission unit (MTU) along a network path (e.g., usually 1500 Bytes for regular Ethernet-based packet switches), an encoded ADU is packetized within a single RTP PDU payload. In another embodiment, an encoded ADU may be aggregated with other one or more ADUs within a single RTP PDU payload. For example, this applies to H.264, H.265, H.266 RTP payload formats for non-video coded layer NALUs such as parameter sets (e.g., video parameters set, sequence parameter set, picture parameter set). In many other embodiments, an ADU may be fragmented over multiple RTP PDUs given that the ADU compressed size may exceed the MTU size minus the overhead of UDP/IP headers, i.e., 1460 Bytes.

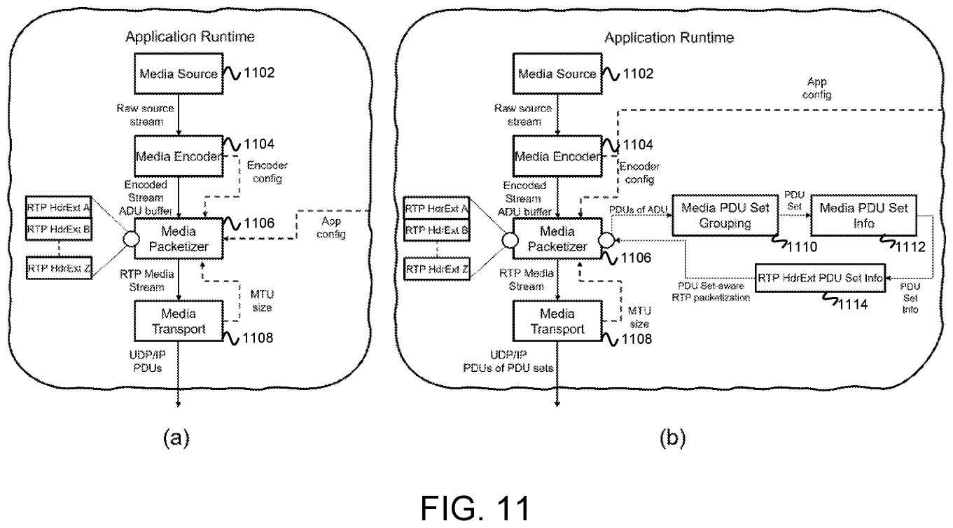

FIG. 11, part a, illustrates an overview of the RTP media packetization procedure applicable at runtime to a video media stream. The media source 1102 block outputs the video input raw source stream according to some raw picture format (e.g., R8G8B8A8, R10G10B10, YUV420 etc.). The raw source stream is inputted directly or upon some transformation (e.g., RGB format to YUV format) to the media encoder 1104 block where a modern hybrid video codec encoding is applied (e.g., H.264, H.265, H.266, VP8, VP9, AV1 etc.) to compress the raw source stream to an encoded bitstream containing multiple ADUs. This process is usually periodic with a frequency determined by the frames per second acquisition and encoding configuration of the real-time processing chain. The encoded ADUs are each outputted by the encoder into the input buffer of a media packetizer 1106. The media packetizer 1106 is configured by an application to use the media codec payload format according to the encoder for packetization of each ADU into RTP PDUs. The media packetizer 1106 is also aware and furthered configured with the MTU size of the transmission path and applies these configurations in part to determine the final packetization of encoded ADUs into RTP PDUs. The latter MTU size awareness is provided in one embodiment by hardcoded fixed values corresponding to typical Internet MTUs capable of transport over both IPv4 and IPv6 networks (e.g., as for instance in the case of the Chromium WebRTC RTP packetizer which is limited to a maximum RTP PDU of 1280 Bytes). In another embodiment the MTU size awareness corresponds to determined MTU size based on probing the transmission path by the MTU Path Discovery procedures, e.g., as per RFC 1191, RFC 8201. The packetizer performs ADU, or alternatively, PDU payload, fragmentation and packetization into one or more RTP PDUs which are buffered into the RTP media stream buffer and released towards the media transport 1108 block implementing the network libraries specific to network transport, e.g., UDP/IP.

The procedure illustrated by FIG. 11, part a, is implemented in some examples by a native RTP library shipped within a networking stack of a mobile, PC or embedded platform (e.g., Android OS®, Windows OS®, Unix/Linux etc.), by a WebRTC runtime within a 3rd party browser implementation (e.g., Chrome, Edge, Mozilla etc.), or by a native WebRTC implementation shipped with a mobile, PC or embedded platform (e.g., Android OS®, Windows OS®, Chrome OS R etc.)

FIG. 11, part b, illustrates on the other hand the same RTP media packetization applicable at runtime to a video media stream with additional PDU set awareness. The PDU set awareness implies in some embodiments both the determination of a PDU set, i.e., the grouping of PDUs into a PDU set, and the signaling of PDU set information, such as a PDU set identifier (e.g., PDU set sequence number), PDU identifier within PDU set (e.g., PDU sequence within PDU set), PDU set size (e.g., in bytes or in number of PDUs), PDU set start, PDU set end and PDU set importance.

As displayed in FIG. 11, part b, in some embodiments, the encoded ADUs are mapped to PDU sets whereby the RTP PDUs representing an ADU are grouped into one PDU set 1110. The grouping is a consequence of the RTP packetizer being provided by upstream processing of the media encoder with the ADU, in effect an RTP payload. This RTP payload is available in the RTP packetizer input buffers whereby successive operations of PDU set determination, packet fragmentation, and RTP packetization follow. The fragmentation and packetization procedures of RTP packetizers take into account the MTU size configuration of the packetizer ensuring that the resulting RTP PDUs do not exceed the MTU threshold taking into account further UDP/IP protocol overheads. In an embodiment, the PDU set information 1112 is obtained after this grouping, whereas the PDU set-aware packetizer 1114 has access to the entire encoded ADU size in bytes, or alternatively, in bits, the start of the ADU, respectively, the PDU set, the end of the ADU, respectively, the PDU set. This information is obtained by the direct mapping of an ADU to the PDU set concept and grouping of resulting PDUs to the PDU set. In another embodiment, the PDU set-aware packetizer 1114 of a specific payload format, e.g., H.264, H.265, H.266, AV1, VP8, VP9, also has access to the ADU payload and ADU header information which in some embodiments contains further information about the ADU type, its presence in a video coded temporal or a spatial layer (in case of layered encodings), its importance, as well as some reference to other ADUs.

In one embodiment, an aggregation of ADUs grouped within one RTP PDU may be outputted by the PDU set-aware packetizer 1114 given said ADUs are released together for processing by the media encoder to the RTP protocol stack and RTP media packetizer 1106. In one example pertaining to H.26x MPEG codecs, this may be applicable to one or more parameter sets and metadata elements (e.g., video parameter set, sequence parameter set, picture parameter set, MPEG SEI metadata) which are packetized together within one RTP PDU. In such a case, for one embodiment the PDU set concept is not applied to the aggregated ADUs within one RTP PDU and default, or alternatively, legacy QoS treatment is applied to the RTP PDU containing aggregated ADUs.

In an embodiment, a PDU set-aware media application running acts as an RTP sender. The RTP sender determines based as per the above details and FIG. 11 an RTP payload size, i.e., the size of one or more ADUs produced by a media encoder. The RTP payload available in the RTP sender input buffer is further passed on to the RTP protocol stack implemented in the user space of an Operation System. The application further enables based on an application or network configuration the PDU set feature and informs the RTP stack of it requesting additional PDU set information (e.g., PDU set sequence number, PDU sequence within PDU set, PDU set size, PDU set end marker, PDU set importance etc.). to the RTP payload. In some sender configurations one RTP payload (i.e., an ADU) is thus mapped 1:1 to a PDU set, whereas in other configurations one or more RTP payloads are mapped to a PDU set. When further enabled by the application to determine PDU set size as part of the PDU set information, the RTP stack determines the PDU set size based in part on at least one of the available RTP payload size, MTU size, and UDP transport socket configuration (e.g., available either based on service configuration or programmatically over Operating System's or similar application-level APIs, such as for instance getsockopt.

As such, for an identified RTP payload mapped to a PDU set, the RTP stack uses the MTU knowledge for the RTP packet fragmentation based on the link MTU size. The MTU size may be statically configured, e.g., to 1280 Bytes for RTP SDUs as in WebRTC, or alternatively, dynamically determined based on ICMP and MTU path discovery procedures. Once the RTP fragmentation is determined, the RTP stack can perform packetization and further release the RTP packets corresponding to the RTP payload, i.e., the PDU set, to the corresponding UDP socket as agreed upon session establishment via the SDP offer/answer procedure. In this flow, the application further provides the RTP stack control to the UDP socket and UDP socket configuration. Consequently, the RTP stack can further determine necessary socket options, i.e., IP version of the transport layer, to determine the protocol headers overhead on the PDU set size. Thus, an RTP stack with PDU set marking capabilities can be aware of the UDP/IP header overhead per packet and take it into account in determining the PDU set size while performing RTP fragmentation and packetization. As such, the RTP stack uses this information with the RTP payload size during RTP packet fragmentation and RTP packetization to determine the PDU set size field in Bytes corresponding to both the size of the RTP payload and the overhead of the UDP/IP headers of the corresponding RTP packets forming the PDU set. In one example, if UDP/IPv4 is used to transport the RTP packets of the application RTP sender the RTP stack can determine an overhead of 20 Bytes (IPv4)+8 Bytes (UDP)=28 Bytes per RTP packet. In another example, if UDP/IPv6 is used to transport the RTP packets the RTP stack can determine an overhead of 40 Bytes (IPv6)+8 Bytes (UDP)=48 Bytes per RTP packet. As a result, the RTP stack can so compute the PDU set size in bytes corresponding to the PDU set size including RTP payload size and the additional UDP/IP protocol headers overheads. This information can in return be signaled further downstream to other media-aware network nodes, or alternatively, to one or more receivers in band for each PDU set as part of a PDU set RTP header extension as detailed in the sequel.

In an example for H.264, the first byte of an ADU, or alternatively, NALU consists of a field ‘F’ marking a I bit ‘forbidden_zero_bit’ indicating the lack or presence of bit errors or syntax violations: a field ‘NRI’ of 2 bits ‘nal_ref_idc’ indicating the importance of the NALU with respect to reference pictures, preserving the semantics of value 00 and non-zero of H.264 specification (i.e., a value of 00 indicates that the content of the NALU is not a reference for any picture for inter-prediction and can be dropped without loss of quality and degradation of references, whereas values greater than 00 indicate that decoding of the NALU is required to maintain the integrity of the inter-prediction referencing; and a field ‘type’ of 5 bits indicating the exact type of the NALU according to the H.264 specification, e.g., coded slice of a non-IDR picture, coded slice of an IDR picture, sequence/video/picture parameter set etc.

In another example for H.265, the first two bytes of an ADU, or alternatively, NALU consists of a field ‘F’ marking a 1 bit ‘fobidden_zero_bit’ indicating the lack or presence of bit errors or syntax violations: a field ‘type’ of 6 bits indicating the type of the NALU, e.g., TRAIL_R, RADL_R, CRA_NUT, sequence/video/parameter set etc., and as such the importance of a NALU may be determined in some examples based on the type of the NALU: a field ‘layer_id’ of 6 bits indicating an identifier to which the NALU belongs (e.g., base layer, enhancement layer etc.); and a field ‘temporal_id’ of 3 bits indicating the temporal identification layer minus 1 to which the NALU belongs to.

In some embodiments, the extracted PDU set information is signaled together with the RTP PDUs encapsulating the PDUs of the PDU set. In such examples, the PDU set information is enclosed within an RTP extension header element of fixed size injected by the media packetizer into the final RTP PDU stream, as outlined by FIG. 8. In these examples, the RTP extension header is enabled by means of SDP offer/answer procedure and the configuration is available to the media packetizer. In addition, the packetization considers in mapping the ADU to PDUs of a PDU set the length of the RTP extension header element together with the length of other SDP-enabled RTP extension headers given the MTU size constraint.

In an embodiment, the PDU set determination procedure described and illustrated in FIG. 11, and correspondingly the associated PDU set information determination, applies an encoder configuration to group ADUs into PDU sets. In an example a video encoder configured to encode 4 slices per video frame the media packetizer will generate for the video frame slice ADUs 4 PDU sets each corresponding to a slice of the video frame. In another embodiment, an encoder produces encoding information metadata (e.g., MPEG Supplemental Enhancement Information (SEI), internal codec message passing and associated implementation-specific interfaces), that may be used to identify a region of interest (e.g., comprised within a tile/slice), a video temporal or a spatial layer to group and limit PDU sets to. In some embodiments, the application may have greater control of the PDU set grouping by exposed application programming interfaces (APIs) within the RTP/WebRTC stacks and library implementations, such that the application can provide a configuration and policy on how finely (i.e., per frame, per slice/tile) the PDU set grouping shall be performed at runtime for an encoded video stream.

In some embodiments, whereby FEC is applied to the RTP transport of media the application runtime determines PDU sets and PDU sets information based additionally on the FEC configuration. In one embodiment where Maximum Distance Separable FEC, e.g., Reed-Solomon, or approximates thereof, e.g., Raptor/RaptorQ, are being used, the minimum number of PDUs required for the recovery of the PDU set, or alternatively, ADU information may be determined based on the FEC configuration, i.e., encoding block size, FEC code rate/redundancy, number of source blocks or source block size. The configuration of the RTP FEC is determined in such examples dynamically by negotiation between a source and receiver over the SDP offer/answer procedure. In such examples, the number of minimum necessary PDUs required to recover the PDU set indicates the resilience information of a PDU set against network and transmission errors leading to PDUs drops. In some embodiments this information is embedded into the PDU set information over RTP extension headers upon enablement of RTP FEC over SDP offer/answer procedure at RTP session establishment for a media stream.

In an embodiment, the reference of a PDU set to other previous or other layers' PDU sets may be indicated by a media packetizer with PDU set awareness and caching capabilities. The media packetizer records thus and keeps track of the inter-PDU set references and decoding dependencies. This is possible given the media packetizer access to the encoded ADU and reference information enclosed thereof with respect to the inter-prediction encoding and decoding processing. In an example, the media packetizer may enclose this information in the RTP extension header PDU set information as a list of references to other previous PDU sets. This allows a PDU set-aware RAN/UPF implementation to drop PDU sets that cannot be decoded given that some of their PDU set references have failed to previously be transmitted over to a receiver endpoint.

In a reduced complexity embodiment, the discarding information may be limited to indicating a discarding bit for PDUs within a PDU set, indicating that in case transmission of one or more PDUs within the PDU set fail to meet the PDB/PSDB, then the rest of the PDUs in the PDU set can be dropped at either UE/RAN or UPF levels. This is beneficial for instance in case of non-referenced NALU, e.g., in H.264 encoded PDU sets whereby the NALU NRI field is ‘00’. Another example where this may be applied is for IDR frames/slices whereby an error within an intra-predicted frame/slice with no other references makes it impossible for the decoder to decode the information. In such examples, a decoder will apply error concealment and the receiver endpoint may trigger a Full Intra Request RTCP feedback, as defined in RFC 5104, requesting a decoder refresh point, as for example a new IDR frame/slice.

In an embodiment, a PDU set information can therefore be formed of a combination of a PDU set identifier field, a PDU sequence number field, a PDU set start marker field, a PDU set end marker field, a PDU set size field, a PDU set importance marker field, a PDU set discarding marker bit field, a PDU set error resilience information field, and a PDU set reference field containing a list of references to one or more PDU sets sequence numbers/identifiers.

In an example, a PDU set sequence number generated sequentially among PDU sets is used to identify a PDU set, whereas in other examples the PDU set is identified based on a random identifier (e.g., a hashcode, a random ID etc.). The PDU sequence number is generated in one example to identify and order the PDUs grouped within a PDU set, whereas the PDU set begin and end markers are meant to mark the first and last PDUs of a PDU set. In some examples, the PDU set size may be signaled in an absolute unit, such as bits, bytes, words etc., or alternatively, may be indicated relative to the concept of PDUs within a PDU set, as the number of PDUs that form the PDU set. The importance marker of a PDU set indicates an importance value of the PDU set out of a predetermined set of importance values, such as HIGH, MEDIUM, LOW, DEFAULT. These importance values indicate in some examples the preferred QoS treatment on a per PDU set level. The number of bits encoding the importance marker information is determined by this set's cardinality, I, i.e., log₂(|I|). The discarding marker indicates in some examples whether a complete PDU set or a subset of a PDU set is safe to be discarded without breaking the application logic or lowering the user Quality of Experience (“QoE”) below a pre-determined minimum threshold. The PDU set error resilience information marks in some examples the fact that the PDU set is forward error corrected. In such examples, the FEC rate and configuration may determine a minimum number of PDUs of the PDU set that need be transmitted to recover correctly the ADU information within the PDU set. The PDU set reference field contains in some examples a list of one or more PDU set sequence numbers which are referenced by the PDU set information and without which the PDU set information cannot be perfectly recovered. This indication is meant to inform the CN, or alternatively, the RAN about the possibility of dropping certain PDUs/PDU sets that cannot be recovered by the application given that some of their referenced information has been previously lost during transmission. In some examples, the PDU set importance and discarding that correspond to a one bit field may be the same, whereby a ‘HIGH’ importance value maps to ‘do not discard’ and a ‘LOW’ importance value maps to ‘free to discard’.

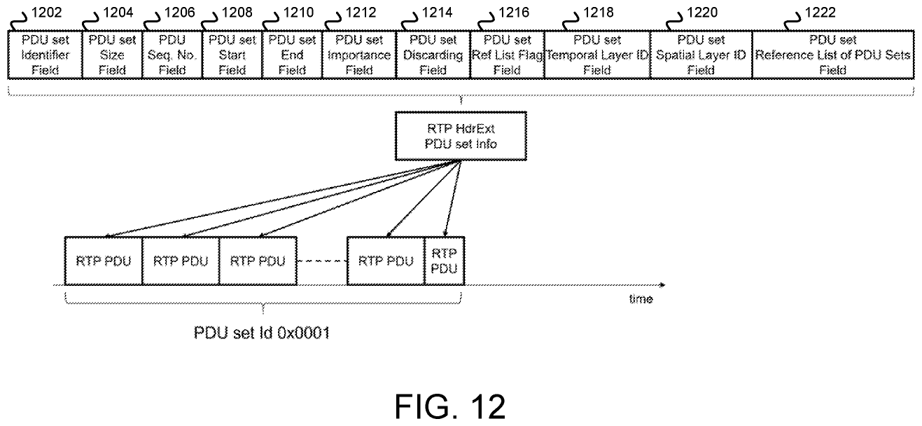

In a second embodiment directed to signaling of PDU set and PDU set information, an example embodiment of the PDU set information data format is presented in FIG. 12 wherein an extended combination of PDU set information fields is displayed for the purpose of a complete example. To this end, the following fields, possibly redundant from a semantic viewpoint, are highlighted together with some reference realizations:

A ‘PDU set identifier’ field 1202 enclosing a PDU set sequence number meant to identify the PDU set. In an example, the PDU set sequence number is associated with a RTP media flow and the first value of the PDU set sequence number is ‘1’, whereby ‘0’ is RESERVED. This is incremented by ‘1’ with each subsequent PDU set generated by the media encoder associated with the RTP media flow, irrespective of the temporal or spatial layer of the encoded ADU. In one example, this field may be encoded within 16 bits. The PDU set sequence shall be wrapped around 65536 such that the valid values area always incremented from 1 to 65535 and then back to 1.

A ‘PDU set size’ 1204 indicating the size of the PDU set in number of PDUs grouped within the PDU set spanning for example an encoding over 8 bits. In another example this field may indicate the PDU set size in terms of bytes spanning in one example a width of 32 bits. The latter example may comprise in some implementations the PDU set size in bytes including the RTP/UDP/IP encapsulation, i.e., taking into account the protocol headers overhead, or alternatively, in other implementations the PDU set size in bytes as the ADU size, or similarly, the RTP payload corresponding to the PDU set.

A ‘PDU sequence number’ 1206 identifying the PDUs forming a PDU set and aiding their in-sequence delivery. In one example this field may span a width of 8 bits limiting a PDU set to contain a maximum number of 256 PDUs, in line with the ‘PDU set size’ value encoding the PDU set size in the number of enclosed PDUs.

A ‘PDU set start’ bit field 1208 indicating in an example for the value of ‘1’ the PDU set start, i.e., the first PDU within a PDU set, and for the value of ‘0’ any other PDU within the PDU set.

A ‘PDU set end’ bit field 1210 indicating in an example for the value of ‘1’ the PDU set end, i.e., the last PDU withing a PDU set, and for the value of ‘0’ any other PDU within the PDU set.

A ‘PDU set importance’ bit field 1212 indicating a binary importance value for the PDU set, for example a value of ‘1’ indicating a HIGH importance PDU set (i.e., corresponding to an intra-decodable frame/slice, intra-frame, keyframe for VP8/9, IDR for H.264, IDR/CRA/BLA/RAP for H.265 etc.), and a value of ‘0’ indicating a LOW/DEFAULT importance PDU set (i.e., corresponding to inter-decodable frame/slice, inter-frame, non-keyframe for V8/9, non-IDR for H.264 etc.).

A ‘PDU set discarding’ bit field 1214 indicating a binary flag valued ‘1’ in an example where the PDU set can be discarded by the UE/RAN and/or CN without corrupting the decoding capability of future PDU sets, e.g., if no inter-prediction references to the PDU set (i.e., frame/slice/tile) exist, and a ‘0’ value otherwise.

A ‘PDU set reference list flag’ bit field 1216 indicating a binary flag valued ‘1’ in an example where at least one reference dependency is being signaled within the PDU set information, and respectively, valued ‘0’ if no reference dependencies are being signaled within the PDU set information.

A ‘PDU set temporal layer ID’ field 1218 identifying the video encoded temporal enhancement layer the PDU set (i.e., frame/slice/tile) belongs to, whereby the base encoding layer is encoded as temporal layer ID ‘0’. In an example this field has a width of 3 bits.

A ‘PDU set spatial layer ID’ field 1220 identifying the video encoded spatial enhancement layer the PDU set (i.e., frame/slice/tile) belongs to, whereby the base encoding layer is encoded as a spatial layer with ID ‘0’. In one example this field has a width of 8 bits.

A ‘PDU set reference list of PDU sets’ field 1222 comprised in an example of a up to 5 PDU set identifier fields marking the reference dependency of the current PDU set to previous/other layers PDUs. In the same example the reference list of PDU sets shall be provided in order of encoding, i.e., preserving wrap-arounds of PDU set identifiers, and in case less than 5 PDU sets are referenced, then the RESERVED PDU set identifier value of ‘0’ shall be used. In this example, a total of 80 bits may be thus used to reference PDU sets dependencies.

In the example of FIG. 12, a fixed RTP extension header payload of 16 bytes is thence provided to encode the PDU set information. The PDU set information is formed in an embodiment by a common information shared by all the PDUs within a PDU set (e.g., PDU set identifier 1202, PDU set size 1204, PDU set reference list flag 1216, PDU set temporal/spatial layer ID 1218, 1220, etc.), and a PDU-specific information (e.g., PDU sequence number 1206, PDU set start flag 1208, PDU set stop flag 1210), In some embodiments therefore, the PDU set information includes the identification of the PDU set and of the PDUs within the PDU set, and a set of attributes of the PDU set. As a consequence, the PDU set identification data and the set of attributes of the PDU set are PDUs-common information of the PDU set, whereas the identification data of the PDUs within the PDU set is PDU-specific PDU set information.

Furthermore, FIG. 12 illustrates that each RTP PDU of a PDU set contains an RTP header extension including an RTP header extension element that consists of corresponding PDU set information data, i.e., both PDUs-common and the PDU-specific PDU set information of the RTP PDU, according to a fixed PDU set information data format.

In some embodiments, only a subset of the extended PDU set information data format illustrated in FIG. 12 is considered. For example, a combination of the PDU set size in the number of PDUs, the start of the PDU set and the end of PDU set is sufficient to delimit the PDU set boundaries and identify individual PDUs within a PDU set. In another example, just the PDU set size in the number of PDUs and a PDU sequence number starting from ‘0’ and incrementing by ‘1’ for each PDU grouped within a PDU set is sufficient to identify PDU set boundaries and its comprised PDUs. Both examples will rely in turn on the PDU set identifier, e.g., as PDU set sequence number, as an identification mean for the PDU sets themselves.

In other embodiments, the PDU set information may be an extension of the draft-ietf-avtext-framemarking-13 RFC whereby additional PDU set-specific information subset, such as PDU set identifier, PDU set size and PDU sequence number, is prepended to the short or long draft-ietf-avtext-framemarking-13 RTP header extension format, cf. “RTP Frame Marking”.

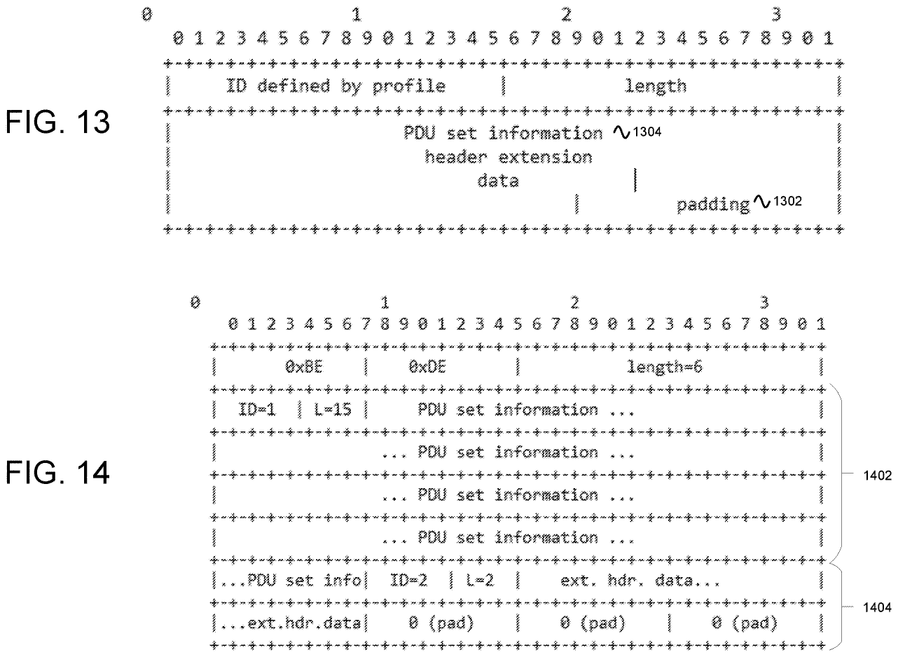

In many embodiments, the basic PDU set information fields described above and illustrated generally in FIG. 12 are byte-aligned. As a result, in some embodiments padding 1302 may be appended at the end of the payload to ensure the 32-bit alignment corresponding to the RTP header extension, cf. “RFC 8285”, as presented in FIG. 13. A complete RTP header extension 1304 representation including the RTP header extension profile determined identifier and length, cf, “RFC 8285”, is provided as reference for some embodiments in FIG. 13.

Albeit in one embodiment the RTP header extension format of FIG. 13 may be sufficient, in other embodiments other RTP header extensions may be necessary to be transmitted simultaneously with the PDU set information. In these latter embodiments, the generic RTP header extensions formatting cf. “RFC 8285” is used to allow for additional extension elements to be signaled multiplexed with the PDU set information data as RTP header extension elements within an RTP header extension.

In one embodiment, the PDU set information is limited to lengths up to 16 bytes. In such an embodiment, the one-byte extension format of the generic RTP header extension mechanism of “RFC 8285” can be used to multiplex the PDU set information with other RTP extension header elements. In an example, such multiplexed RTP extension header elements may consist of 3GPP extension header for coordination of video orientation, i.e., ‘urn:3gpp:video-orientation’, transmission time offsets, i.e., RFC 5450, ‘urn: ietf: params: rtp-hdrext:toffset’, client-to-mixer audio level indications, e.g., RFC 6464 or RFC 6465, etc. This mechanism allows thus the multiplexing of other header extension elements universally available in WebRTC browser/native (e.g., Chrome, Edge, Mozilla Firefox) and RTP native implementations together with the PDU set information header extension element over the same RTP/SRTP PDUs of a PDU set. For example, one realization of an embodiment implementing the one-byte extension format of “RFC 8285” and the previously described generic PDU set information payload as one of the RTP header extension elements is illustrated in FIG. 14.

In FIG. 14, the PDU set information 1402 payload of 16 bytes, corresponding to the previous example illustrated by FIG. 12 is transported over a one-byte generic RTP header extension mechanism (identified by profile ID 0xBEDE). The overall RTP extension header element is 12 words. The PDU set information data is the first RTP header extension element, preceding two other extension elements. This reduces complexity on a media-aware network equipment, or similarly, a PDU set-aware UPF, to process the PDU set information without the need for buffering and additional processing of unnecessary RTP header extension elements. The RTP header extension is additionally padded with 3 bytes to ensure the overall RTP header extension 32-bit alignment. Therefore, in some embodiments the PDU set information may be placed first to facilitate the UPF filtering and processing of PDU set information without increasing the need of buffering additional unnecessary RTP header extension elements. In other embodiments, the placement of the PDU set information is up to the packetizer implementation given the negotiated extension mapping via SDP and the active and enabled RTP extensions.

In other embodiments, whereby multiplexing with longer RTP extension header elements is performed, the PDU set information can still preserve a fixed size, e.g., of 16 bytes, allowing it to be encapsulated into either a one-byte RTP header extension element or a two-byte RTP header extension element. In such embodiments, however a subset of the other multiplexed RTP extension header elements that exceed the 16 bytes payload limit of the one-byte header format, are encapsulated in the two-byte header format according to the generic RTP header extension mechanism of “RFC 8285”. This allows multiplexing with RTP extension header elements of up to 256 bytes fulfilling most requirements of available RTP extension headers within state-of-art IETF specifications, WebRTC native/browser stacks, and RTP native library implementations. This mechanism of mixing one-byte and two-byte generic RTP extension header formats across a RTP session or media flow is possible based on “RFC 8285” and negotiated upon SDP offer/answer procedure via the attribute ‘a-extmap-allow-mixed’ used at either the session or media level of an RTP session. The mixing of format types is activated when both the SDP offer and answer from the client offerer, and respectively, from the answerer contain the attribute extmap-allow-mixed.

In another embodiment, the PDU set information payload can thence flexibly be encapsulated in the one-byte generic RTP extension header payload format or the two-byte generic RTP extension header payload format. In one example, this is performed when the answerer does not support mixing of the formats and some RTP extension header elements exceed the 16 bytes size limit of the one-byte format. In such an example all the RTP extension header elements are encapsulated in the two-byte RTP extension header format and multiplexed as the RTP extension header.

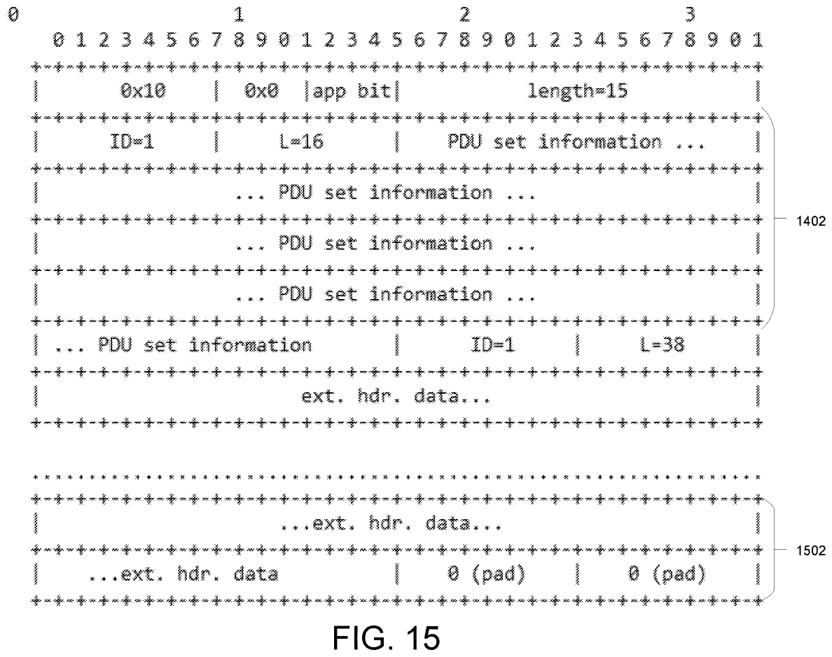

An example of multiplexing involving a two-byte PDU set information RTP extension header element and a second two-byte RTP extension header element is provided in FIG. 15. The same generic PDU set information 1402 of FIG. 14 is multiplexed with a second generic RTP extension 1502 encapsulated within the two-byte generic RTP extension format. The second extension includes padding with null bytes to ensure that the resulting multiplexed RTP header extension achieves 32-bit alignment.

The signaling of the local ID and extension mapping corresponding to the RTP header extension element of the PDU set information data is in some embodiments following the SDP signaling as per “RFC 8285”. In such embodiments, during the SDP offer/answer procedure the client sender and the offerer negotiate and determine the RTP extension mapping, the local extension element ID, the Uniform Resource Identifier (URI), the direction (e.g., ‘sendrecv’, ‘sendonly’, ‘recvonly’, ‘inactive’) and the namespace (i.e., RTP session-wide or RTP media-wide) of the PDU set information extension header element transported by RTP PDUs over the session/media flows. Given that the PDU set information is source-produced and meant to be consumed within the 5GS for optimized QoS handling, in one embodiment the PDU set information RTP header extension mapping may be decorated with the attribute ‘sendonly’. This indicates that the PDU set information is only populated along one direction from the source of the RTP session or media flow to the receiver.

An example of an SDP answer snapshot is listed below for the case of a one-byte generic RTP header extension mechanism mapping a local ID 42 to an URI corresponding to a 3GPP PDU set information payload, e.g., ‘urn:3gpp:pdu-set-info’, at the media level for a H.264 media flow. The SDP response (e.g., a UPF, a UE) indicates that for the video media flow the answerer accepts to receive the PDU set information by the attribute ‘recvonly’. This maps according to RFC 8285 to an offerer marking the PDU set information RTP extension header element as ‘sendonly’ for the said video media flow. In addition, the URI is obtained from a central registry hosting the OpenXR data model and syntax associated and mapped to the local ID 1. The SDP answer example also contains other 2 extension elements, i.e., a 3GPP Coordination Video Orientation (CVO) with a precision of 6 bits and local ID 3, and a transmission time offset extension header element, cf. RFC 5450, with local ID 2.

An example listing SDP answer includes:

...
m=video 50000 RTP/AVP 96
a=rtpmap:96 H264/90000
a=fmtp:96 media=video; clock-rate=90000; encoding-name=H264
a = extmap:1/recvonly urn:3gpp:pdu-set-info
a = extmap:2 urn:ietf:params:rtp-hdrext:toffset
a = extmap:3 urn:3gpp:video-orientation:6
...

In some embodiments, the RTP header extension element of a PDU set information produced at the source may be ignored by a destination endpoint (e.g., a legacy UE) or a network waypoint (e.g., a legacy UPF implementation, a TURN server etc.) that do not have the knowledge of PDU set concept and are unable to interpret and process the PDU set information.

The known set value of a reserved field may comprise in some examples an all ‘0’s or ‘1’s field, or similarly, one or more ‘0x00’ or ‘0x11’ byte fields etc.

The PDU set sequence number is used to identify the PDU set and in some examples may be generated sequentially among PDU sets, whereas in other examples it may be generated based on a random identifier procedure (e.g., hashing, randomization etc.). The PDU sequence number is generated to identify and order the PDUs grouped within a PDU set, whereas the PDU set begin and end markers are meant to indicate the first and last PDUs of a PDU set. The PDU set size may be signaled in an absolute unit of measure for digital information, such as bits, bytes, words etc., or alternatively, may be indicated relative to the concept of PDUs within a PDU set, as the number of PDUs that form the PDU set. The importance marker of a PDU set indicates an importance value of the PDU set out of a predetermined set of importance values, e.g., HIGH, MEDIUM, LOW, DEFAULT, to indicate preferred QoS treatment on a per PDU set level. The number of bits encoding the importance marker information is determined by the set cardinality of importance values, I, i.e., log₂(|I|). The discarding marker indicates whether a complete PDU set or a subset of a PDU set is safe to be discarded without breaking the application logic or lowering the user Quality of Experience (QoE) below a pre-determined minimum threshold. The PDU set error resilience information may in some examples mark the fact that the PDU set is forward error corrected (FEC) and the FEC rate indicating thus a minimum number of PDUs of the PDU set that need be transmitted to recover correctly the ADU information within the PDU set. The PDU set reference field contains in some examples a list of one or more PDU set sequence numbers which are referenced by the PDU set information and without which the PDU set information cannot be recovered successfully. This indication is meant to inform the network, or alternatively, the radio access network about the possibility of dropping certain PDU sets that cannot be recovered by the application given that some of their referenced information has been previously lost during transmission. In some examples, the PDU set importance and discarding corresponding to one bit field may be the same whereby a ‘HIGH’ importance value maps to ‘do not discard’ and a ‘LOW’ importance value maps to ‘free to discard’.

The determination of the PDU set grouping and the generation of the PDU set information to fill the PDU set extension header element may be based in some example implementations on video encoded network abstraction layer units (NALU) and their header information indicating the type of video encoded frame/slice/layer information comprised by the NALU payload. In another example, an encoder configuration may be used to group ADUs into PDU sets such that for a video encoder configured to encode 4 slices per video frame will generate for the video frame ADU 4 PDU sets each corresponding to a slice of the video frame. An encoder may produce in some examples encoding information metadata as MPEG Supplemental Enhancement Information (SEI) that may be used to identify video temporal or spatial layers to group PDU sets. In some implementations, the application may have greater control of the PDU set grouping by exposed application programming interfaces (APIs) within the RTP/WebRTC libraries and implementations, such that the application can provide a configuration and indications on how the PDU set grouping shall be performed at runtime for a video source.

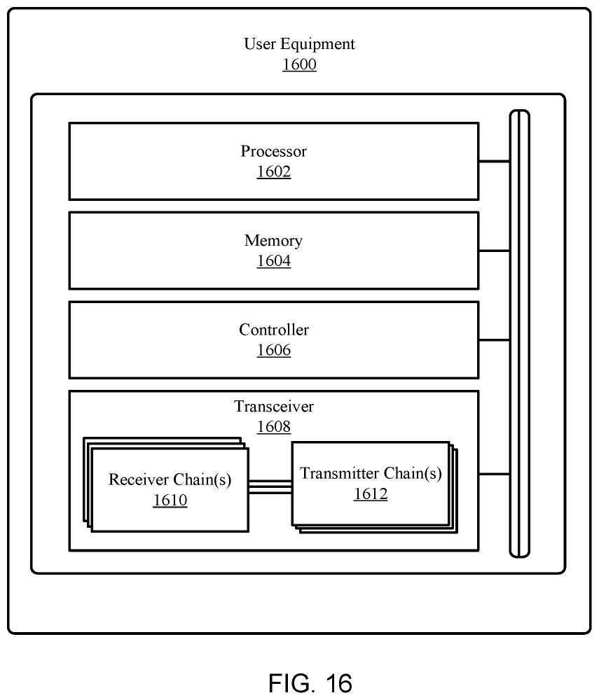

FIG. 16 illustrates an example of a UE 1600 in accordance with aspects of the present disclosure. The UE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the UE 1600 to perform various functions of the present disclosure.

The memory 1604 may include volatile or non-volatile memory. The memory 1604 may store computer-readable, computer-executable code including instructions when executed by the processor 1602 cause the UE 1600 to perform various functions described herein. The code may be stored in a non-transitory computer-readable medium such the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the UE 1600 to perform one or more of the functions described herein (e.g., executing, by the processor 1602, instructions stored in the memory 1604). For example, the processor 1602 may support wireless communication at the UE 1600 in accordance with examples as disclosed herein. The UE 1600 may be configured to support a means to encode media of an application into a plurality of ADUs as logically independent units of information, group, by an application RTP sender routine, each ADU into one or more PDU sets, determine, for each of the PDU sets, PDU set information, encapsulate the PDU set information for each of the PDUs in the PDU set in an extension header element packetized within an RTP extension header of an RTP PDU corresponding to the RTP PDU payload of each of the one or more PDUs of the PDU set, and transmit the RTP PDUs comprising the PDU set information.

In one embodiment, the PDU set information optimizes media transfer given QoS requirements of the application. In one embodiment, optimization of the media transfer based on the PDU set information given the QoS requirements comprises a mapping of the PDU set to a data radio bearer, a group scheduling of radio resources for the transmission of PDUs within the PDU set over the air, a dynamic adaptation of radio modulation and coding schemes policies for transmission of the PDU set over the air, a dynamic decision to drop from an over the air transmission queue one or more PDUs out of one or more PDU sets, the dropped PDUs determined to be unnecessary for the application based on at least one of a signaled PDU set discarding marker and on their dependency on other PDUs or PDU sets that failed to be transmitted successfully, or a combination thereof.

In one embodiment, the extension header element encapsulating the PDU set information has a fixed size and comprises a plurality of information fields, a plurality of reserved fields, or a combination thereof.

In one embodiment, the set of PDU set attributes of the PDU set information comprises a PDU set sequence number/identifier field, a PDU sequence number field, a PDU set start marker field, a PDU set end marker field, a PDU set size field indicating the PDU set size in bytes, a PDU set size field indicating the PDU set size in the number of contained PDUs, a PDU set importance field, a PDU set discarding marker bit field, a PDU set encoding layer identifier field, a PDU set error resilience information field, a PDU set reference field containing a list of references to one or more PDU sets sequence numbers/identifiers, or a combination thereof.

In one embodiment, the PDU set importance field is comprised of log₂|I| bits of information indicating the PDU set importance value out of a set of I importance values containing at least two elements, and wherein at least one value corresponds to a ‘HIGH’ importance and at least one value corresponds to a ‘LOW’ importance.

In one embodiment, the PDU set importance field linearly encodes l=16 importance values, wherein a ‘0’ encoding value indicates a highest PDU set importance and a ‘15’ encoding value indicates a lowest PDU set importance.

In one embodiment, the RTP extension header comprises at least a second extension header element suffixed to the extension header element encapsulating the PDU set information as a first extension header element.

In one embodiment, the PDU set comprises an encoded video frame, an encoded video frame partition as an encoded video slice, or alternatively, an encoded video tile, an encoded video temporal layer, an encoded video spatial layer, or a combination thereof.

In one embodiment, the PDU set grouping and the PDU set information determination is based on encoded ADU information, an encoding configuration, an encoding information metadata, an application-determined configuration, or a combination thereof.

The controller 1606 may manage input and output signals for the UE 1600. The controller 1606 may also manage peripherals not integrated into the UE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the UE 1600 may include at least one transceiver 1608. In some other implementations, the UE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas for receiving the signal over the air or wireless medium. The receiver chain 1610 may include at least one amplifier (e.g., a low-noise amplifier (LNA)) configured to amplify the received signal. The receiver chain 1610 may include at least one demodulator configured to demodulate the received signal and obtain the transmitted data by reversing the modulation technique applied during transmission of the signal. The receiver chain 1610 may include at least one decoder for decoding and processing the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

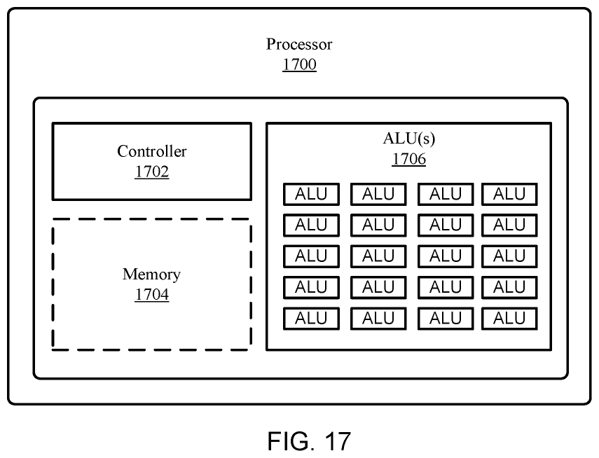

FIG. 17 illustrates an example of a processor 1700 in accordance with aspects of the present disclosure. The processor 1700 may be an example of a processor configured to perform various operations in accordance with examples as described herein. The processor 1700 may include a controller 1702 configured to perform various operations in accordance with examples as described herein. The processor 1700 may optionally include at least one memory 1704, which may be, for example, an L1/L2/L3 cache. Additionally, or alternatively, the processor 1700 may optionally include one or more arithmetic-logic units (ALUs) 1706. One or more of these components may be in electronic communication or otherwise coupled (e.g., operatively, communicatively, functionally, electronically, electrically) via one or more interfaces (e.g., buses).

The processor 1700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1702 may be configured to manage and coordinate various operations (e.g., signaling, receiving, obtaining, retrieving, transmitting, outputting, forwarding, storing, determining, identifying, accessing, writing, reading) of the processor 1700 to cause the processor 1700 to support various operations in accordance with examples as described herein. For example, the controller 1702 may operate as a control unit of the processor 1700, generating control signals that manage the operation of various components of the processor 1700. These control signals include enabling or disabling functional units, selecting data paths, initiating memory access, and coordinating timing of operations.

The controller 1702 may be configured to fetch (e.g., obtain, retrieve, receive) instructions from the memory 1704 and determine subsequent instruction(s) to be executed to cause the processor 1700 to support various operations in accordance with examples as described herein. The controller 1702 may be configured to track memory address of instructions associated with the memory 1704. The controller 1702 may be configured to decode instructions to determine the operation to be performed and the operands involved. For example, the controller 1702 may be configured to interpret the instruction and determine control signals to be output to other components of the processor 1700 to cause the processor 1700 to support various operations in accordance with examples as described herein. Additionally, or alternatively, the controller 1702 may be configured to manage flow of data within the processor 1700. The controller 1702 may be configured to control transfer of data between registers, arithmetic logic units (ALUs), and other functional units of the processor 1700.

The memory 1704 may include one or more caches (e.g., memory local to or included in the processor 1700 or other memory, such RAM, ROM, DRAM, SDRAM, SRAM, MRAM, flash memory, etc. In some implementations, the memory 1704 may reside within or on a processor chipset (e.g., local to the processor 1700). In some other implementations, the memory 1704 may reside external to the processor chipset (e.g., remote to the processor 1700).

The memory 1704 may store computer-readable, computer-executable code including instructions that, when executed by the processor 1700, cause the processor 1700 to perform various functions described herein. The code may be stored in a non-transitory computer-readable medium such as system memory or another type of memory. The controller 1702 and/or the processor 1700 may be configured to execute computer-readable instructions stored in the memory 1704 to cause the processor 1700 to perform various functions. For example, the processor 1700 and/or the controller 1702 may be coupled with or to the memory 1704, the processor 1700, the controller 1702, and the memory 1704 may be configured to perform various functions described herein. In some examples, the processor 1700 may include multiple processors and the memory 1704 may include multiple memories. One or more of the multiple processors may be coupled with one or more of the multiple memories, which may, individually or collectively, be configured to perform various functions herein.

The one or more ALUs 1706 may be configured to support various operations in accordance with examples as described herein. In some implementations, the one or more ALUs 1706 may reside within or on a processor chipset (e.g., the processor 1700). In some other implementations, the one or more ALUs 1706 may reside external to the processor chipset (e.g., the processor 1700). One or more ALUs 1706 may perform one or more computations such as addition, subtraction, multiplication, and division on data. For example, one or more ALUs 1706 may receive input operands and an operation code, which determines an operation to be executed. One or more ALUs 1706 be configured with a variety of logical and arithmetic circuits, including adders, subtractors, shifters, and logic gates, to process and manipulate the data according to the operation. Additionally, or alternatively, the one or more ALUs 1706 may support logical operations such as AND, OR, exclusive-OR (XOR), not-OR (NOR), and not-AND (NAND), enabling the one or more ALUs 1706 to handle conditional operations, comparisons, and bitwise operations.

The processor 1700 may support wireless communication in accordance with examples as disclosed herein. The processor 1700 may be configured to or operable to support a means to encode media of an application into a plurality of ADUs as logically independent units of information, group, by an application RTP sender routine, each ADU into one or more PDU sets, determine, for each of the PDU sets, PDU set information, encapsulate the PDU set information for each of the PDUs in the PDU set in an extension header element packetized within an RTP extension header of an RTP PDU corresponding to the RTP PDU payload of each of the one or more PDUs of the PDU set, and transmit the RTP PDUs comprising the PDU set information.

In one embodiment, the PDU set information optimizes media transfer given QoS requirements of the application. In one embodiment, optimization of the media transfer based on the PDU set information given the QoS requirements comprises a mapping of the PDU set to a data radio bearer, a group scheduling of radio resources for the transmission of PDUs within the PDU set over the air, a dynamic adaptation of radio modulation and coding schemes policies for transmission of the PDU set over the air, a dynamic decision to drop from an over the air transmission queue one or more PDUs out of one or more PDU sets, the dropped PDUs determined to be unnecessary for the application based on at least one of a signaled PDU set discarding marker and on their dependency on other PDUs or PDU sets that failed to be transmitted successfully, or a combination thereof.

In one embodiment, the extension header element encapsulating the PDU set information has a fixed size and comprises a plurality of information fields, a plurality of reserved fields, or a combination thereof.

In one embodiment, the set of PDU set attributes of the PDU set information comprises a PDU set sequence number/identifier field, a PDU sequence number field, a PDU set start marker field, a PDU set end marker field, a PDU set size field indicating the PDU set size in bytes, a PDU set size field indicating the PDU set size in the number of contained PDUs, a PDU set importance field, a PDU set discarding marker bit field, a PDU set encoding layer identifier field, a PDU set error resilience information field, a PDU set reference field containing a list of references to one or more PDU sets sequence numbers/identifiers, or a combination thereof.

In one embodiment, the PDU set importance field is comprised of log₂|I| bits of information indicating the PDU set importance value out of a set of I importance values containing at least two elements, and wherein at least one value corresponds to a ‘HIGH’ importance and at least one value corresponds to a ‘LOW’ importance.

In one embodiment, the PDU set importance field linearly encodes l=16 importance values, wherein a ‘0’ encoding value indicates a highest PDU set importance and a ‘15’ encoding value indicates a lowest PDU set importance.

In one embodiment, the RTP extension header comprises at least a second extension header element suffixed to the extension header element encapsulating the PDU set information as a first extension header element.

In one embodiment, the PDU set comprises an encoded video frame, an encoded video frame partition as an encoded video slice, or alternatively, an encoded video tile, an encoded video temporal layer, an encoded video spatial layer, or a combination thereof.

In one embodiment, the PDU set grouping and the PDU set information determination is based on encoded ADU information, an encoding configuration, an encoding information metadata, an application-determined configuration, or a combination thereof.

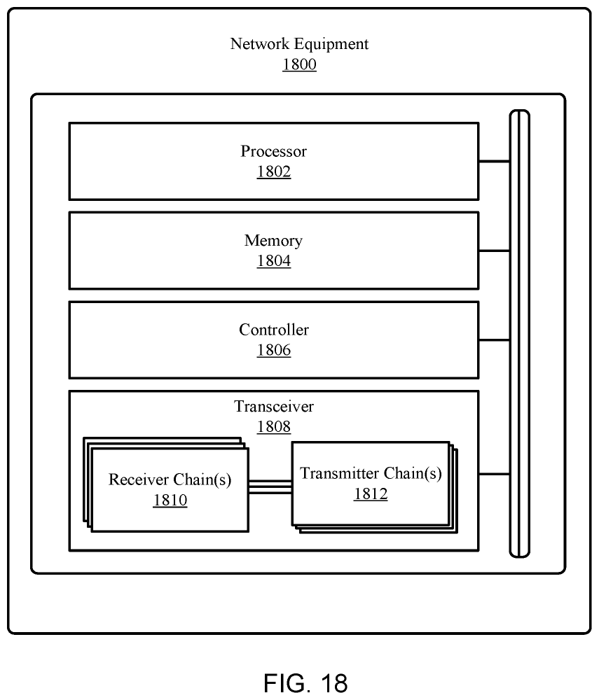

FIG. 18 illustrates an example of an NE 1800 in accordance with aspects of the present disclosure. The NE 1800 may include a processor 1802, a memory 1804, a controller 1806, and a transceiver 1808. The processor 1802, the memory 1804, the controller 1806, or the transceiver 1808, or various combinations thereof or various components thereof may be examples of means for performing various aspects of the present disclosure as described herein. These components may be coupled (e.g., operatively, communicatively, functionally, electronically, electrically) via one or more interfaces.

The processor 1802, the memory 1804, the controller 1806, or the transceiver 1808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1802 may include an intelligent hardware device (e.g., a general-purpose processor, a DSP, a CPU, an ASIC, an FPGA, or any combination thereof). In some implementations, the processor 1802 may be configured to operate the memory 1804. In some other implementations, the memory 1804 may be integrated into the processor 1802. The processor 1802 may be configured to execute computer-readable instructions stored in the memory 1804 to cause the NE 1800 to perform various functions of the present disclosure.

The memory 1804 may include volatile or non-volatile memory. The memory 1804 may store computer-readable, computer-executable code including instructions when executed by the processor 1802 cause the NE 1800 to perform various functions described herein. The code may be stored in a non-transitory computer-readable medium such the memory 1804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1802 and the memory 1804 coupled with the processor 1802 may be configured to cause the NE 1800 to perform one or more of the functions described herein (e.g., executing, by the processor 1802, instructions stored in the memory 1804). For example, the processor 1802 may support wireless communication at the NE 1800 in accordance with examples as disclosed herein. The NE 1800 may be configured to support a means to encode media of an application into a plurality of ADUs as logically independent units of information, group, by an application RTP sender routine, each ADU into one or more PDU sets, determine, for each of the PDU sets, PDU set information, encapsulate the PDU set information for each of the PDUs in the PDU set in an extension header element packetized within an RTP extension header of an RTP PDU corresponding to the RTP PDU payload of each of the one or more PDUs of the PDU set, and transmit the RTP PDUs comprising the PDU set information.

In one embodiment, the PDU set information optimizes media transfer given QoS requirements of the application. In one embodiment, optimization of the media transfer based on the PDU set information given the QoS requirements comprises a mapping of the PDU set to a data radio bearer, a group scheduling of radio resources for the transmission of PDUs within the PDU set over the air, a dynamic adaptation of radio modulation and coding schemes policies for transmission of the PDU set over the air, a dynamic decision to drop from an over the air transmission queue one or more PDUs out of one or more PDU sets, the dropped PDUs determined to be unnecessary for the application based on at least one of a signaled PDU set discarding marker and on their dependency on other PDUs or PDU sets that failed to be transmitted successfully, or a combination thereof.

In one embodiment, the extension header element encapsulating the PDU set information has a fixed size and comprises a plurality of information fields, a plurality of reserved fields, or a combination thereof.

In one embodiment, the set of PDU set attributes of the PDU set information comprises a PDU set sequence number/identifier field, a PDU sequence number field, a PDU set start marker field, a PDU set end marker field, a PDU set size field indicating the PDU set size in bytes, a PDU set size field indicating the PDU set size in the number of contained PDUs, a PDU set importance field, a PDU set discarding marker bit field, a PDU set encoding layer identifier field, a PDU set error resilience information field, a PDU set reference field containing a list of references to one or more PDU sets sequence numbers/identifiers, or a combination thereof.

In one embodiment, the PDU set importance field is comprised of log₂|I| bits of information indicating the PDU set importance value out of a set of I importance values containing at least two elements, and wherein at least one value corresponds to a ‘HIGH’ importance and at least one value corresponds to a ‘LOW’ importance.

In one embodiment, the PDU set importance field linearly encodes l=16 importance values, wherein a ‘0’ encoding value indicates a highest PDU set importance and a ‘15’ encoding value indicates a lowest PDU set importance.

In one embodiment, the RTP extension header comprises at least a second extension header element suffixed to the extension header element encapsulating the PDU set information as a first extension header element.

In one embodiment, the PDU set comprises an encoded video frame, an encoded video frame partition as an encoded video slice, or alternatively, an encoded video tile, an encoded video temporal layer, an encoded video spatial layer, or a combination thereof.

In one embodiment, the PDU set grouping and the PDU set information determination is based on encoded ADU information, an encoding configuration, an encoding information metadata, an application-determined configuration, or a combination thereof.

The controller 1806 may manage input and output signals for the NE 1800. The controller 1806 may also manage peripherals not integrated into the NE 1800. In some implementations, the controller 1806 may utilize an operating system such as iOS®, ANDROID®, WINDOWS®, or other operating systems. In some implementations, the controller 1806 may be implemented as part of the processor 1802.

In some implementations, the NE 1800 may include at least one transceiver 1808. In some other implementations, the NE 1800 may have more than one transceiver 1808. The transceiver 1808 may represent a wireless transceiver. The transceiver 1808 may include one or more receiver chains 1810, one or more transmitter chains 1812, or a combination thereof.

A receiver chain 1810 may be configured to receive signals (e.g., control information, data, packets) over a wireless medium. For example, the receiver chain 1810 may include one or more antennas for receiving the signal over the air or wireless medium. The receiver chain 1810 may include at least one amplifier (e.g., a low-noise amplifier (LNA)) configured to amplify the received signal. The receiver chain 1810 may include at least one demodulator configured to demodulate the received signal and obtain the transmitted data by reversing the modulation technique applied during transmission of the signal. The receiver chain 1810 may include at least one decoder for decoding and processing the demodulated signal to receive the transmitted data.

A transmitter chain 1812 may be configured to generate and transmit signals (e.g., control information, data, packets). The transmitter chain 1812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1812 may also include at least one power amplifier configured to amplify the modulated signal to an appropriate power level suitable for transmission over the wireless medium. The transmitter chain 1812 may also include one or more antennas for transmitting the amplified signal into the air or wireless medium.

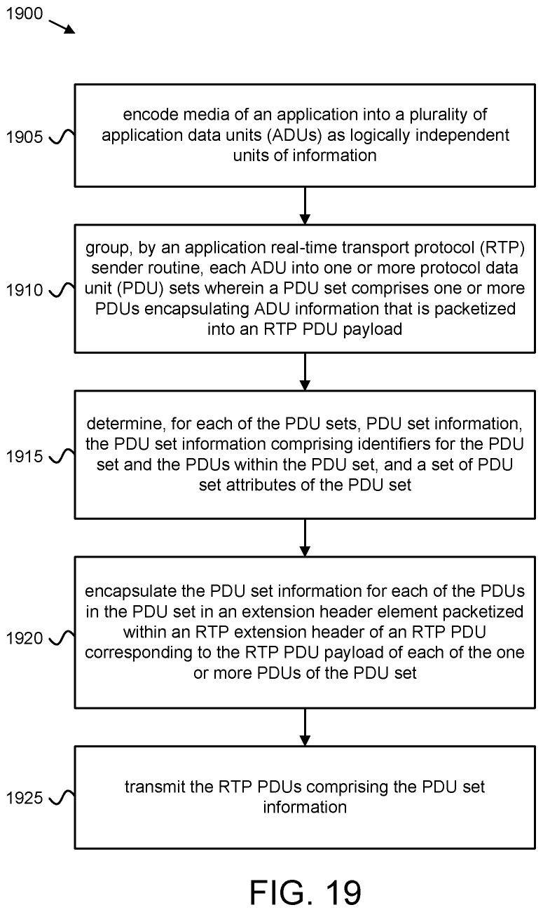

FIG. 19 illustrates a flowchart of a method in accordance with aspects of the present disclosure. The operations of the method may be implemented by a UE as described with reference to FIG. 16, a processor as described with reference to FIG. 17, and/or a base station, or alternatively, an application server, as described with reference to FIG. 18. In some implementations, the UE, processor, and/or NE may execute a set of instructions to control the function elements of the UE to perform the described functions.

At 1905, the method may include encoding media of an application into a plurality of ADUs as logically independent units of information. The operations of 1905 may be performed in accordance with examples as described herein. In some implementations, aspects of the operations of 1905 may be performed by a UE as described with reference to FIG. 16, a processor as described with reference to FIG. 17, and/or a base station, or alternatively, an application server, as described with reference to FIG. 18.

At 1910, the method may include grouping, by an application RTP sender routine, each ADU into one or more PDU sets wherein a PDU set comprises one or more PDUs encapsulating ADU information that is packetized into an RTP PDU payload. The operations of 1910 may be performed in accordance with examples as described herein. In some implementations, aspects of the operations of 1910 may be performed by a UE as described with reference to FIG. 16, a processor as described with reference to FIG. 17, and/or a base station, or alternatively, an application server, as described with reference to FIG. 18.

At 1915, the method may include determining, for each of the PDU sets, PDU set information, the PDU set information comprising identifiers for the PDU set and the PDUs within the PDU set, and a set of PDU set attributes of the PDU set. The operations of 1915 may be performed in accordance with examples as described herein. In some implementations, aspects of the operations of 1915 may be performed by a UE as described with reference to FIG. 16, a processor as described with reference to FIG. 17, and/or a base station, or alternatively, an application server, as described with reference to FIG. 18.

At 1920, the method may include encapsulating the PDU set information for each of the PDUs in the PDU set in an extension header element packetized within an RTP extension header of an RTP PDU corresponding to the RTP PDU payload of each of the one or more PDUs of the PDU set. The operations of 1920 may be performed in accordance with examples as described herein. In some implementations, aspects of the operations of 1920 may be performed by a UE as described with reference to FIG. 16, a processor as described with reference to FIG. 17, and/or a base station, or alternatively, an application server, as described with reference to FIG. 18.

At 1925, the method may include transmitting the RTP PDUs comprising the PDU set information. The operations of 1925 may be performed in accordance with examples as described herein. In some implementations, aspects of the operations of 1925 may be performed by a UE as described with reference to FIG. 16, a processor as described with reference to FIG. 17, and/or a base station, or alternatively, an application server, as described with reference to FIG. 18.

It should be noted that the method described herein describes a possible implementation, and that the operations and the steps may be rearranged or otherwise modified and that other implementations are possible.

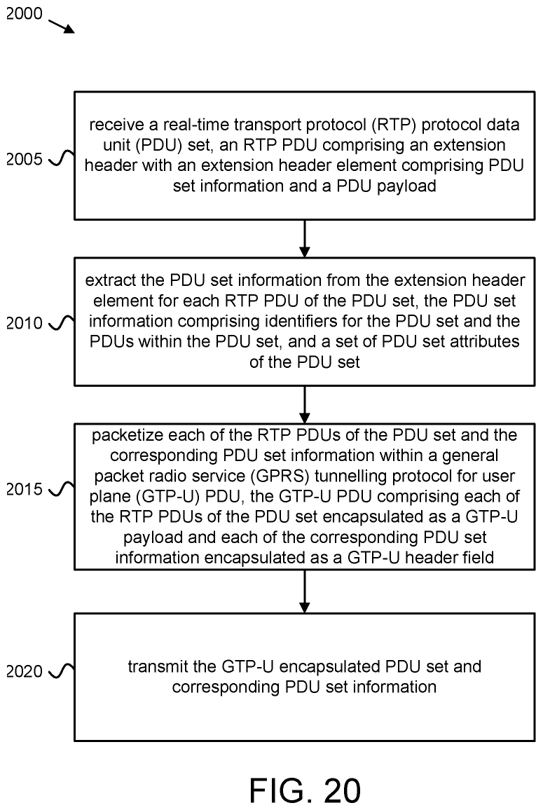

FIG. 20 illustrates a flowchart of a method in accordance with aspects of the present disclosure. The operations of the method may be implemented by a UE as described with reference to FIG. 16, a processor as described with reference to FIG. 17, and/or a base station, or alternatively, a network function (e.g., a UPF) on an NE, as described with reference to FIG. 18. In some implementations, the UE, processor, and/or NE may execute a set of instructions to control the function elements of the UE to perform the described functions.

At 2005, the method may include receiving an RTP PDU set, an RTP PDU comprising an extension header with an extension header element comprising PDU set information and a PDU payload. The operations of 2005 may be performed in accordance with examples as described herein. In some implementations, aspects of the operations of 2005 may be performed by a UE as described with reference to FIG. 16, a processor as described with reference to FIG. 17, and/or a base station, or alternatively, a network function (e.g., a UPF) on an NE, as described with reference to FIG. 18.

At 2010, the method may include extracting the PDU set information from the extension header element for each RTP PDU of the PDU set, the PDU set information comprising identifiers for the PDU set and the PDUs within the PDU set, and a set of PDU set attributes of the PDU set. The operations of 2010 may be performed in accordance with examples as described herein. In some implementations, aspects of the operations of 2010 may be performed by a UE as described with reference to FIG. 16, a processor as described with reference to FIG. 17, and/or a base station, or alternatively, a network function (e.g., a UPF) on an NE, as described with reference to FIG. 18.

At 2015, the method may include packetizing each of the RTP PDUs of the PDU set and the corresponding PDU set information within a GTP-U PDU, the GTP-U PDU comprising each of the RTP PDUs of the PDU set encapsulated as a GTP-U payload and each of the corresponding PDU set information encapsulated as a GTP-U header field. The operations of 2015 may be performed in accordance with examples as described herein. In some implementations, aspects of the operations of 2015 may be performed by a UE as described with reference to FIG. 16, a processor as described with reference to FIG. 17, and/or a base station, or alternatively, a network function (e.g., a UPF) on an NE, as described with reference to FIG. 18.

At 2020, the method may include transmitting the GTP-U encapsulated PDU set and corresponding PDU set information. The operations of 2020 may be performed in accordance with examples as described herein. In some implementations, aspects of the operations of 2020 may be performed by a UE as described with reference to FIG. 16, a processor as described with reference to FIG. 17, and/or a base station, or alternatively, a network function (e.g., a UPF) on an NE, as described with reference to FIG. 18.

It should be noted that the method described herein describes a possible implementation, and that the operations and the steps may be rearranged or otherwise modified and that other implementations are possible.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network equipment (NE) for wireless communication, comprising:
at least one memory;
at least one processor coupled with the at least one memory and configured to cause the NE to:
encode media of an application into a plurality of application data units (ADUs) as logically independent units of information;
group, by an application real-time transport protocol (RTP) sender routine, each ADU into one or more protocol data unit (PDU) sets wherein a PDU set comprises one or more PDUs encapsulating ADU information that is packetized into an RTP PDU payload;
determine, for each of the PDU sets, PDU set information, the PDU set information comprising identifiers for the PDU set and the PDUs within the PDU set, and a set of PDU set attributes of the PDU set;
encapsulate the PDU set information for each of the PDUs in the PDU set in an extension header element packetized within an RTP extension header of an RTP PDU corresponding to the RTP PDU payload of each of the one or more PDUs of the PDU set; and
transmit the RTP PDUs comprising the PDU set information.

2. The NE of claim 1, wherein the PDU set information optimizes media transfer given quality of service (QoS) requirements of the application.

3. The NE of claim 2, wherein optimization of the media transfer based on the PDU set information given the QoS requirements comprises a mapping of the PDU set to a data radio bearer, a group scheduling of radio resources for the transmission of PDUs within the PDU set over the air, a dynamic adaptation of radio modulation and coding schemes policies for transmission of the PDU set over the air, a dynamic decision to drop from an over the air transmission queue one or more PDUs out of one or more PDU sets, the dropped PDUs determined to be unnecessary for the application based on at least one of a signaled PDU set discarding marker and on their dependency on other PDUs or PDU sets that failed to be transmitted successfully, or a combination thereof.

4. The NE of claim 1, wherein the extension header element encapsulating the PDU set information has a fixed size and comprises a plurality of information fields, a plurality of reserved fields, or a combination thereof.

5. The NE of claim 1, wherein the set of PDU set attributes of the PDU set information comprises:
a PDU set sequence number/identifier field;
a PDU sequence number field;
a PDU set start marker field;
a PDU set end marker field;
a PDU set size field indicating the PDU set size in bytes;
a PDU set size field indicating the PDU set size in the number of contained PDUs;
a PDU set importance field;
a PDU set discarding marker bit field;
a PDU set encoding layer identifier field;
a PDU set error resilience information field;
a PDU set reference field containing a list of references to one or more PDU sets sequence numbers/identifiers;
or a combination thereof.

6. The NE of claim 5, wherein the PDU set importance field is comprised of log₂|I| bits of information indicating the PDU set importance value out of a set of I importance values containing at least two elements, and wherein at least one value corresponds to a ‘HIGH’ importance and at least one value corresponds to a ‘LOW’ importance.

7. The NE of claim 6, wherein the PDU set importance field linearly encodes l=16 importance values, wherein a ‘1’ encoding value indicates a highest PDU set importance, a ‘15’ encoding value indicates a lowest PDU set importance, and a ‘0’ encoding value indicates an undefined PDU set importance.

8. The NE of claim 1, wherein the RTP extension header comprises at least a second extension header element suffixed to the extension header element encapsulating the PDU set information as a first extension header element.

9. The NE of claim 1, wherein the PDU set comprises an encoded video frame, an encoded video frame partition as an encoded video slice, or alternatively, an encoded video tile, an encoded video temporal layer, an encoded video spatial layer, or a combination thereof.

10. The NE of claim 1, wherein the PDU set grouping and the PDU set information determination is based on encoded ADU information, an encoding configuration, an encoding information metadata, an application-determined configuration, or a combination thereof.

11. A processor for wireless communication, comprising:
at least one controller coupled with the at least one memory and configured to cause the processor to:
encode media of an application into a plurality of application data units (ADUs) as logically independent units of information;
group, by an application real-time transport protocol (RTP) sender routine, each ADU into one or more protocol data unit (PDU) sets wherein a PDU set comprises one or more PDUs encapsulating ADU information that is packetized into an RTP PDU payload;
determine, for each of the PDU sets, PDU set information, the PDU set information comprising identifiers for the PDU set and the PDUs within the PDU set, and a set of PDU set attributes of the PDU set;
encapsulate the PDU set information for each of the PDUs in the PDU set in an extension header element packetized within an RTP extension header of an RTP PDU corresponding to the RTP PDU payload of each of the one or more PDUs of the PDU set; and
transmit the RTP PDUs comprising the PDU set information.

12. The processor of claim 11, wherein the PDU set information optimizes media transfer given quality of service (QoS) requirements of the application.

13. The processor of claim 12, wherein optimization of the media transfer based on the PDU set information given the QoS requirements comprises a mapping of the PDU set to a data radio bearer, a group scheduling of radio resources for the transmission of PDUs within the PDU set over the air, a dynamic adaptation of radio modulation and coding schemes policies for transmission of the PDU set over the air, a dynamic decision to drop from an over the air transmission queue one or more PDUs out of one or more PDU sets, the dropped PDUs determined to be unnecessary for the application based on at least one of a signaled PDU set discarding marker and on their dependency on other PDUs or PDU sets that failed to be transmitted successfully, or a combination thereof.

14. The processor of claim 11, wherein the extension header element encapsulating the PDU set information has a fixed size and comprises a plurality of information fields, a plurality of reserved fields, or a combination thereof.

15. The processor of claim 11, wherein the set of PDU set attributes of the PDU set information comprises:
a PDU set sequence number/identifier field;
a PDU sequence number field;
a PDU set start marker field;
a PDU set end marker field;
a PDU set size field indicating the PDU set size in bytes;
a PDU set size field indicating the PDU set size in the number of contained PDUs;
a PDU set importance field;
a PDU set discarding marker bit field;
a PDU set encoding layer identifier field;
a PDU set error resilience information field;
a PDU set reference field containing a list of references to one or more PDU sets sequence numbers/identifiers;
or a combination thereof.

16. The processor of claim 15, wherein the PDU set importance field is comprised of log₂|I| bits of information indicating the PDU set importance value out of a set of I importance values containing at least two elements, and wherein at least one value corresponds to a ‘HIGH’ importance and at least one value corresponds to a ‘LOW’ importance.

17. The processor of claim 16, wherein the PDU set importance field linearly encodes l=16 importance values, wherein a ‘1’ encoding value indicates a highest PDU set importance, a ‘15’ encoding value indicates a lowest PDU set importance, and a ‘0’ encoding value indicates an undefined PDU set importance.

18. The processor of claim 11, wherein the RTP extension header comprises at least a second extension header element suffixed to the extension header element encapsulating the PDU set information as a first extension header element.

19. A method performed by an NE, the method comprising:
encoding media of an application into a plurality of application data units (ADUs) as logically independent units of information;
grouping, by an application real-time transport protocol (RTP) sender routine, each ADU into one or more protocol data unit (PDU) sets wherein a PDU set comprises one or more PDUs encapsulating ADU information that is packetized into an RTP PDU payload;
determining, for each of the PDU sets, PDU set information, the PDU set information comprising identifiers for the PDU set and the PDUs within the PDU set, and a set of PDU set attributes of the PDU set;
encapsulating the PDU set information for each of the PDUs in the PDU set in an extension header element packetized within an RTP extension header of an RTP PDU corresponding to the RTP PDU payload of each of the one or more PDUs of the PDU set; and
transmitting the RTP PDUs comprising the PDU set information.

20. A network equipment (NE) for wireless communication, comprising:
at least one memory;
at least one processor coupled with the at least one memory and configured to cause the NE to:
receive a real-time transport protocol (RTP) protocol data unit (PDU) set, an RTP PDU comprising an extension header with an extension header element comprising PDU set information and a PDU payload;
extract the PDU set information from the extension header element for each RTP PDU of the PDU set, the PDU set information comprising identifiers for the PDU set and the PDUs within the PDU set, and a set of PDU set attributes of the PDU set;
packetize each of the RTP PDUs of the PDU set and the corresponding PDU set information within a general packet radio service (GPRS) tunnelling protocol for user plane (GTP-U) PDU, the GTP-U PDU comprising each of the RTP PDUs of the PDU set encapsulated as a GTP-U payload and each of the corresponding PDU set information encapsulated as a GTP-U header field; and
transmit the GTP-U encapsulated PDU set and corresponding PDU set information.
